(19) United States
(12) Patent Application Publication
(10) Pub. No.: US 2026/0057245 A1
(43) Pub. Date: Feb. 26, 2026

(54) System and Method for Co-Optimizing Memory Optimizations with Parallelism for Large Scale Distributed Training

(71) Applicant: CentML AI Inc., Toronto (CA)

(72) Inventors: Zhanda ZHU, Toronto (CA); Christina GIANNOULA, Toronto (CA); Muralidhar ANDOORVEEDU, Sunnyvale, CA (US); Karttikeya MANGALAM, Berkeley, CA (US); Bojian ZHENG, Toronto (CA); Gennady PEKHIMENKO, Oakville (CA)

(73) Assignee: CentML AI Inc., Toronto (CA)

(21) Appl. No.: 19/306,513

(22) Filed: Aug. 21, 2025

Related U.S. Application Data
(60) Provisional application No. 63/686,344, filed on Aug. 23, 2024.

(51) Int. Cl. G06N 3/098

(52) U.S. Cl. CPC G06N 3/098

(57) ABSTRACT

A system method for performing distributed training of models. The method includes co-optimizing memory optimizations with parallelism to increase model training throughput under a memory constraint by orchestrating a plurality of optimizations to utilize system resources in consideration of computation, communication and memory footprint. The system can include an overlap-centric schedule template that determines granularity and order of how techniques utilized by the plurality of optimizations are applied to a model. The overlap-centric schedule template mitigates tuning complexity by applying heuristics to orchestrate optimizations in an overlapped manner.

### CROSS-REFERENCE TO RELATED APPLICATION(S)

This application claims priority to U.S. Provisional Patent Application No. 63/686,344 filed on Aug. 23, 2024, the contents of which are incorporated herein by reference in their entirety.

### TECHNICAL FIELD

The following generally relates to parallelism for large scale distributed training and, more particularly to co-optimized memory optimizations with such parallelism.

### BACKGROUND

Large-scale Deep Learning (DL) models demonstrate remarkable capabilities across a wide range of NLP and CV tasks [21,46, 62-64]. Large Language Models (LLMs), especially, have shown superior performance, garnering significant interest in various fields [5, 25, 57]. However, their considerably increased sizes and dataset requirements have escalated computational and memory demands, making an efficient distributed training system important [67, 72], as minor reductions in the training time matter due to the substantial financial and environmental costs involved [24, 49, 73].

Various techniques have been proposed to optimize distributed training, including parallelism and memory optimizations. Data parallelism [1, 42], sharded data parallelism [65, 85], tensor parallelism [40, 72], and pipeline parallelism [31, 34, 43, 52] are proposed to partition the workloads onto multiple devices, enabling efficient parallelized execution. Memory footprint reduction techniques like activation checkpointing [17, 37, 39, 86] and offloading [27, 30, 60, 66, 68, 69] are employed to alleviate the memory pressure. To further mitigate the communication overhead introduced by parallelism and offloading, some works propose to overlap the communication with computation [11, 40, 60, 81].

Therefore, the optimization problem of distributed training can be formulated as choosing the best combination of techniques to maximize training throughput while keeping the memory usage under the hardware memory limit. To achieve this key objective, parallelism [67, 72, 87] and memory optimizations [37, 39, 60, 86] are suggested to be applied simultaneously, as both provide trade-offs between memory footprint reduction and computation or communication overhead.

As Table 1 below shows, manual methods such as MegatronLM [72] and DeepSpeed [67], among others [66, 68, 85], are then developed to provide partial optimizations. However, they require users to specify configurations to achieve the best system performance, which can be challenging even for experienced users [50, 87]. In Table 1, note that DP, SDP, TP, and PP mean data, sharded data, tensor, and pipeline parallelism respectively. P, G, O, and A under offloading denote parameter, gradient, optimizer states, activation offloading, respectively. Circle for optimizations represents functionality support and control flexibility. Circle for tuning represents whether the system can tune all optimizations it supports. Here the table distinguishes DeepSpeed-ZeRO from ZeROoffload and ZeRO-infinity.

TABLE 1
Comparison of Distributed Training Systems

| | Parallelism | | | | Offloading | | | | Act. | Auto-Tuning |
|---|---|---|---|---|---|---|---|---|---|---|
| | DP | SDP | TP | PP | P | G | O | A | Ckpt. | Capability |
| PyTorch-FSDP [85] | ✓ | ● | X | X | [symbol] | [symbol] | [symbol] | ◯ | ✓ | ◯ |
| Megatron-LM [72] | ✓ | [symbol] | ✓ | ✓ | ◯ | ◯ | ◯ | ◯ | ✓ | ◯ |
| DeepSpeed-ZeRO [67] | ✓ | ● | ✓ | ✓ | ◯ | ◯ | ◯ | ◯ | ✓ | ◯ |
| ZeRO-Offload [68] | ✓ | ● | ✓ | X | ◯ | ◯ | [symbol] | ◯ | ✓ | ◯ |
| ZeRO-Infinity [66] | ✓ | ● | ✓ | X | [symbol] | [symbol] | [symbol] | [symbol] | ✓ | ◯ |
| Alpa [87] | ✓ | ● | ✓ | ✓ | ◯ | ◯ | ◯ | ◯ | ✓ | [symbol] |
| Slapo [12] | ✓ | ● | ✓ | ✓ | ◯ | ◯ | ◯ | ◯ | ✓ | [symbol] |
| AdaPipe [75] | ✓ | ● | ✓ | ✓ | ◯ | ◯ | ◯ | ◯ | ✓ | [symbol] |
| Aceso [45] | ✓ | ◯ | ✓ | ✓ | ◯ | ◯ | ◯ | ◯ | ✓ | ● |
| Mist | ✓ | ● | ✓ | ✓ | ● | ● | ● | ● | ✓ | ● |

To address this issue, automatic distributed training systems are proposed [12, 41, 45, 50, 75, 76, 80, 87]. Given model and hardware specifications, they construct the search space of optimizations and automatically find optimal combination of techniques.

Existing distributed training systems are found to suffer from three key shortcomings. First, they may fail to comprehensively co-optimize memory optimizations with parallelism. As shown in the second part of Table 1, like manual methods, existing automatic systems either need to rely on manually selected memory optimizations before parallelization tuning [48, 50, 76, 87], or only co-optimize partial memory optimizations with certain parallelism [12, 45, 75], due to the lack of functionality support or tuning support of certain optimizations, leading to sub-optimal strategies. Second, the existing training systems may not be overlap-aware beyond basic gradient synchronization overlap. Computation-communication overlap for techniques, such as sharded data parallelism, pipeline parallelism, and offloading, can be important for the training throughput [26, 60, 72, 85]. However, it is found that nearly all the existing automatic methods mentioned above do not consider these overlap opportunities beyond basic gradient all-reduce, underestimating the performance of optimization combinations that can be overlapped. Third, the existing systems are typically not inter-microbatch imbalance-aware in pipeline parallelism. To efficiently tune the pipeline parallelism, existing automatic parallelism planners use the averaged microbatch time across all microbatches to represent the stage time [45, 87], implicitly assuming that all microbatches within a pipeline stage are the same. However, it has been found that the first and the last microbatch consumes more time since it may need extra operations for weights all-gathering, gradient reduce-scattering, and optimizer offloading.

In practice, ignoring the inter-microbatch imbalance introduces inaccurate end-to-end performance prediction, and as discussed herein, it can lead to about 9% slowdown compared to the optimal solutions. The major challenge of memory footprint reduction techniques and parallelism co-optimization is the exploded number of combinations. Simply tuning the best parallelization strategy or activation checkpointing for a single device already takes several hours [37, 87] and tuning all optimizations simultaneously costs even longer time, putting design challenges on each components of the new system.

### SUMMARY

To address the aforementioned shortcomings and issues, the present disclosure proposes a memory, overlap, and imbalance-aware automatic distributed training system (also referred to herein as “Mist” for ease of reference) that co-optimizes memory footprint reduction techniques with parallelism. Memory footprint reduction techniques, although they have been primarily designed to alleviate memory pressure, can significantly enhance performance, since they assist in balancing trade-offs between runtime overhead and memory footprint reduction. For instance, applying offloading optimization can free up some memory in GPU devices, which can then be leveraged to reduce the tensor parallelism (TP) or pipeline parallelism (PP) size, thereby reducing communication overheads or pipeline bubbles during training. Generally, exploiting memory footprint reduction techniques to release some memory footprint in GPU devices can be leveraged to: 1) reduce the TP size, thus mitigating communication overheads; 2) reduce the PP size, thus eliminating pipeline bubbles; and (3) increase the batch size, improving kernel efficiency. Conversely, applying less aggressively memory footprint reduction optimizations results in higher GPU memory usage, which increases the partitioning across devices, thus incurring higher performance overheads related to parallelism. Therefore, additional GPU memory can be gained by applying more aggressive memory footprint reduction techniques, which come with some added overhead. This memory can then be used to reduce the overhead of other optimizations. As long as the benefit from reducing the overhead outweighs the additional cost incurred by the memory footprint reduction techniques, overall training efficiency improves.

Overall, distributed training constitutes an optimization problem that can be formulated as choosing the best combination of all available techniques (both parallelism and memory footprint reduction techniques) to maximize training efficiency, while keeping the memory usage lower than the available hardware memory capacity.

In the present disclosure, the system may include three main components:

(1) a fine-grained overlap-centric schedule template that determines the granularity and order of how techniques are applied upon the model. With appropriate heuristic, it provides a fine-grained control of these optimizations to ensure the effectiveness, while keeping the search space feasible. By carefully orchestrating optimizations, it aims to maximize the computation-communication overlap opportunities to mitigate the overhead associated with these techniques.

(2) an interference-aware symbolic analysis system that provides accurate and efficient predictions of the symbolic runtime and memory usage expressions, considering the interference from the overlapped operations. To achieve efficient predictions, Mist may only run a single simulation pass for optimizations represented as symbols, and outputs the symbolic expressions or functions of the system metrics. To provide accurate prediction involving multiple optimizations, Mist develops an interference-aware performance model.

(3) an imbalance-aware hierarchical auto-tuner that decouples the tuning into an inter-stage imbalance-aware Mixed Integer Linear Programming (MILP) problem and an intra-stage Constrained Optimization problem, employing an off-the-shelf solver [28] and batched value evaluations to efficiently determine the best configuration, respectively.

The present disclosure evaluates Mist using a wide variety of LLMs, training configurations, and GPU architectures, and demonstrate that Mist outperforms prior works [45, 67, 72]. The evaluation results show that Mist can achieve an average of 1.28× (up to 1.73×) and 1.27× (up to 2.04×) speedup compared to state-of-the-art manual implementation Megatron-LM and automatic method Aceso, respectively, across different GPUs, models, and training configurations.

In the present disclosure, certain contributions can be summarized as follows:

a) identifying the shortcomings of existing distributed training systems and proposing to comprehensively co-optimize memory optimizations with parallelism to exploit system resources and accelerate large scale distributed training, for example to provide a highly efficient and easy-to-use automatic distributed training framework for LLMs.

b) building Mist, a memory, overlap, and imbalance-aware automatic distributed training system that strikes the best trade-off among computation, communication, and memory footprint. Mist can reduce the exploded search space of combining various optimization techniques via an overlap-centric schedule template, interference-aware symbolic analyzer, and imbalance-aware hierarchical auto-tuner that decouples the optimization process into two stages and connects them through sampling (e.g., Pareto frontier), addressing microbatch variability and leveraging overlap opportunities in PP. Mist further implements a symbolic analysis system that generates symbolic expressions for workload characteristics to quickly explore the exploded search space.

c) evaluating Mist on various models in both NVLink systems (NVIDIA A100 GPUs [55]) and PCle systems (NVIDIA L4 GPUs [56]) compared to multiple strong baselines and showing that the proposed system can significantly outperform prior works under various training configurations.

In one aspect, there is provided a method of performing distributed training of models, comprising: co-optimizing memory optimizations with parallelism to increase model training throughput under a memory constraint by orchestrating a plurality of optimizations to utilize system resources in consideration of computation, communication and memory footprint.

In example embodiments, the method includes obtaining an overlap-centric schedule template that determines granularity and order of how techniques utilized by the plurality of optimizations are applied to a model.

In example embodiments, the overlap-centric schedule template mitigates tuning complexity by applying heuristics to orchestrate optimizations in an overlapped manner.

In example embodiments, the method includes obtaining the model and corresponding input data; and annotating the model and input data with symbolic shapes and applying a symbolic tracer to obtain a symbolic shape computational graph.

In example embodiments, the method includes analyzing the symbolic shape computational graph and the overlap-centric schedule template to derive a peak memory expression and runtime function whose inputs are optimization-related symbols.

In example embodiments, a single simulation pass is run for optimizations represented as symbols and symbolic expressions or functions of the system metrics are output.

In example embodiments, the method includes decoupling tuning into inter-stage and intra-stage tuning using an imbalance-aware hierarchical auto-tuner.

In example embodiments, inter-stage tuning addresses inter-stage and inter-microbatch imbalances inherent in pipeline parallelism.

In example embodiments, intra-stage tuning evaluates the symbolic memory expression and runtime function with optimization values in a batched way to find a pareto-optimal series of 2D parallelism and offloading plans for each potential inter-stage candidate.

In example embodiments, the method includes utilizing an execution engine to perform the optimizations in distributed training operations.

In example embodiments, the execution engine is configured to perform at least one of auto-pipelining, overlapped offloading, and memory buffer optimization.

In another aspect, there is provided a computer readable medium storing computer executable instructions for performing distributed training of models, comprising computer executable instructions for performing the methods above.

In another aspect, there is provided a computing system comprising at least one processor and at least one memory, the at least one memory storing computer executable instructions for performing distributed training of models, comprising computer executable instructions for performing the methods above.

### BRIEF DESCRIPTION OF THE DRAWINGS

Embodiments will now be described with reference to the appended drawings wherein:

FIG. 1 is an example of a computing environment in which distributed training system may be deployed.

FIG. 2 is a block diagram of an example of a configuration for a computing device.

FIG. 3a illustrates optimization configurations.

FIG. 3b illustrates motivational examples of tuning parallelism with memory optimizations.

FIG. 3c illustrates a motivational example showing the speedup source of a comprehensive co-optimization.

FIG. 3d illustrates growth in the number of configurations within the search space as each optimization is incrementally added.

FIG. 4a is a block diagram illustrating a high-level system overview of the proposed system, herein referred to as Mist.

FIG. 4b illustrates an overlap schedule template for the system.

FIG. 4c provides a comparison of the symbolic performance analyzer with the traditional analyzer.

FIG. 5a illustrates a total runtime of a pipeline considering inter-microbatch imbalance.

FIG. 5b provides an example of defining symbolic model configurations and inputs, followed by symbolic execution.

FIG. 5c illustrates an example of Algorithm 1 for batched interference estimation.

FIG. 6 shows end-to-end training throughput on L4 GPUs and A100 GPUs with FlashAttention enabled, shown in charts (a) through (f).

FIGS. 7a and 7b show end-to-end training throughput on L4 GPUs and A100 GPUs without FlashAttention.

FIG. 8 illustrates relative averaged speedup of searching over different search spaces for GPT model on 8, 16, and 32 L4 GPUs.

FIG. 9 illustrates performance of GPT-3 with different numbers of layers on 32 L4 GPUs, the left chart without FlashAttention and the right chart with FlashAttention.

FIG. 10 illustrates performance of GPT-3 22B with different global batch sizes on 32 L4 GPUs.

FIG. 11 illustrates tuning time of the GPT-3 22B on 32 GPUs.

### DETAILED DESCRIPTION

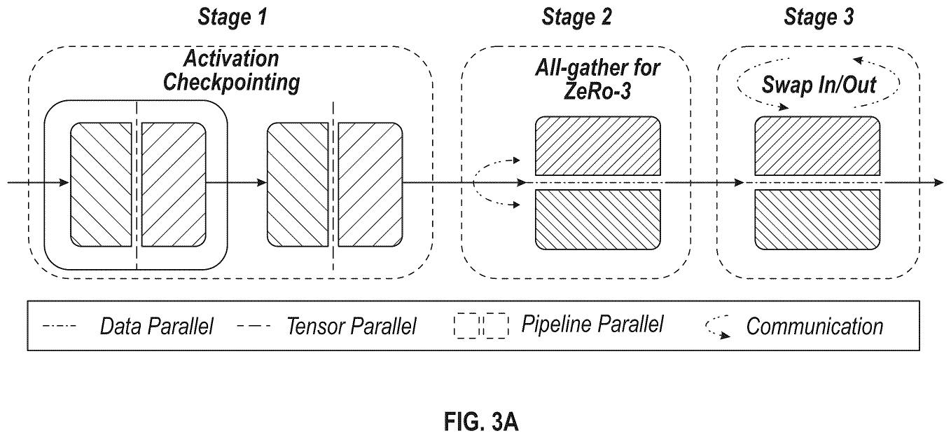

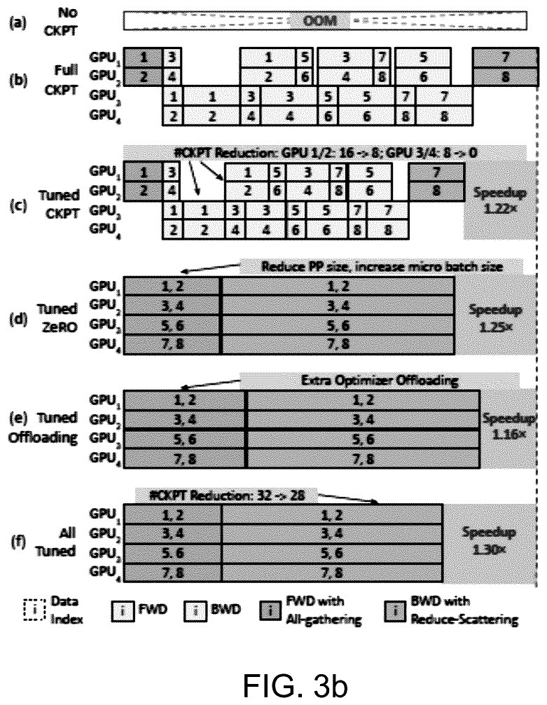

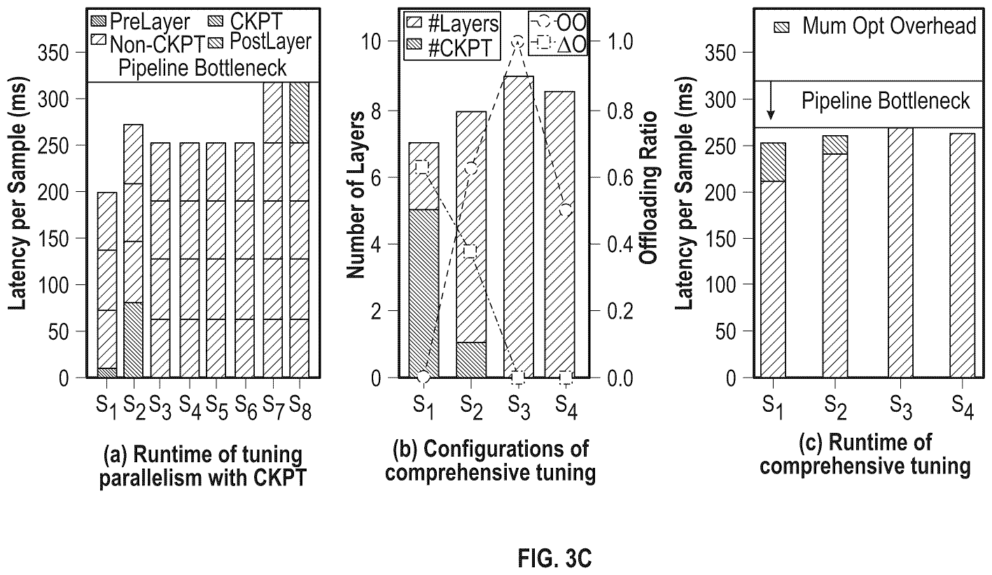

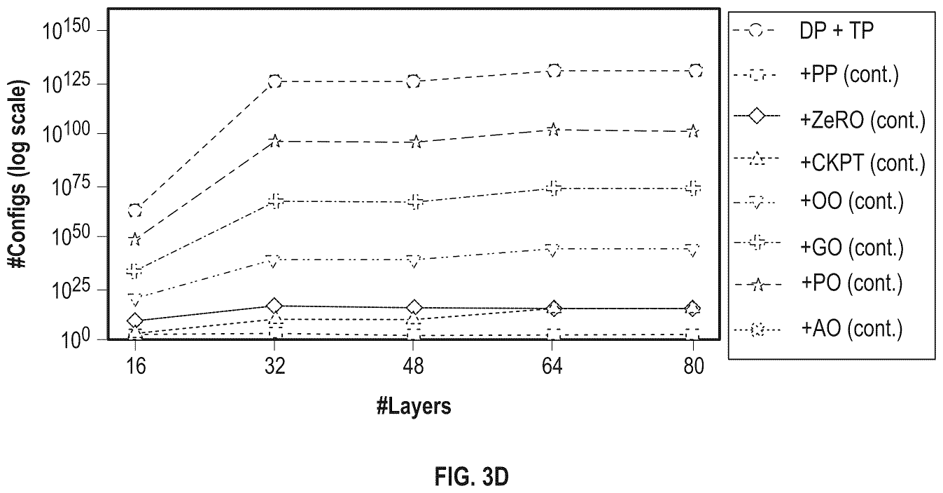

Various parallelism strategies, such as data, sharded data, tensor, and pipeline parallelism; and memory optimizations, such as activation checkpointing and offloading; have been proposed to work together to accelerate large scale distributed training. To find the best combination of these techniques, automatic distributed training strategy planners are proposed. However, existing systems are found to not be able to comprehensively co-optimize memory optimizations with parallelism, lack advanced overlap awareness, and do not consider inter-microbatch imbalance in pipeline parallelism, leading to sub-optimal performance. As shown in FIG. 3a, different parallelism and memory optimizations can be applied in combination.

To address these shortcomings and the design challenge of the exploded search space, the following proposes a system referred to interchangeably as “Mist”, a memory, overlap, and imbalance-aware automatic distributed training system.

Mist may comprise three key components: (1) an overlap-centric schedule template that orchestrates techniques in an overlapped manner and mitigates the tuning complexity, (2) an interference-aware symbolic analysis system that provides accurate and efficient predictions of the runtime and memory usage in the form of symbolic expressions, and (3) an imbalance-aware hierarchical auto-tuner that decouples the tuning into an inter-stage imbalance-aware MILP problem and an intra-stage Constrained Optimization problem.

The evaluation results show that Mist can achieve an average of 1.28× (up to 1.73×) and 1.27× (up to 2.04×) speedup compared to state-of-the art manual implementation Megatron-LM and automatic method Aceso, respectively.

### 1. Computing Environment

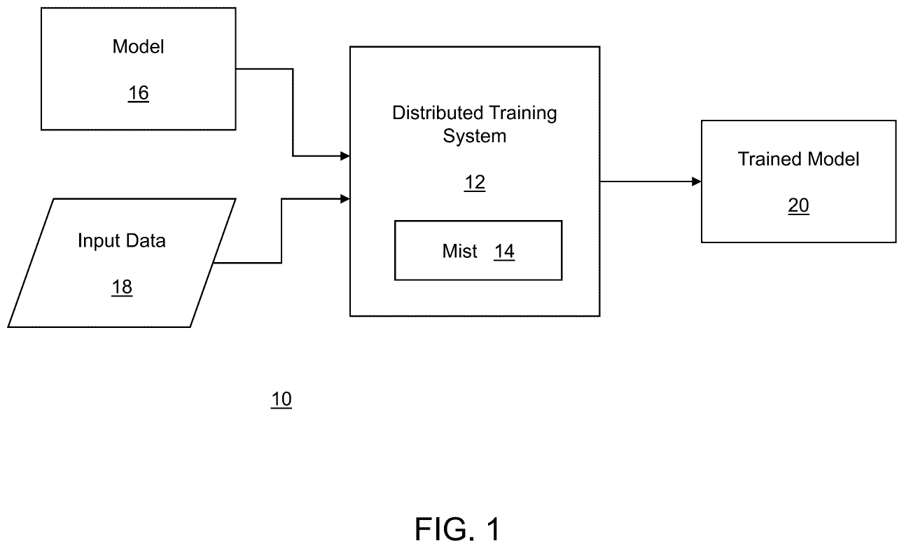

Referring now to FIG. 1, an example of a computing environment 10 is shown in which the present methods, processes and optimizations may be deployed. The computing environment 10 includes a distributed training system 12, which may include the presently described system, namely Mist 14. The distributed training system 12 obtains a model 16 and/or input data 18 and utilizes Mist 14 to optimize distributed training operations as described herein to thereby generate a trained model 20.

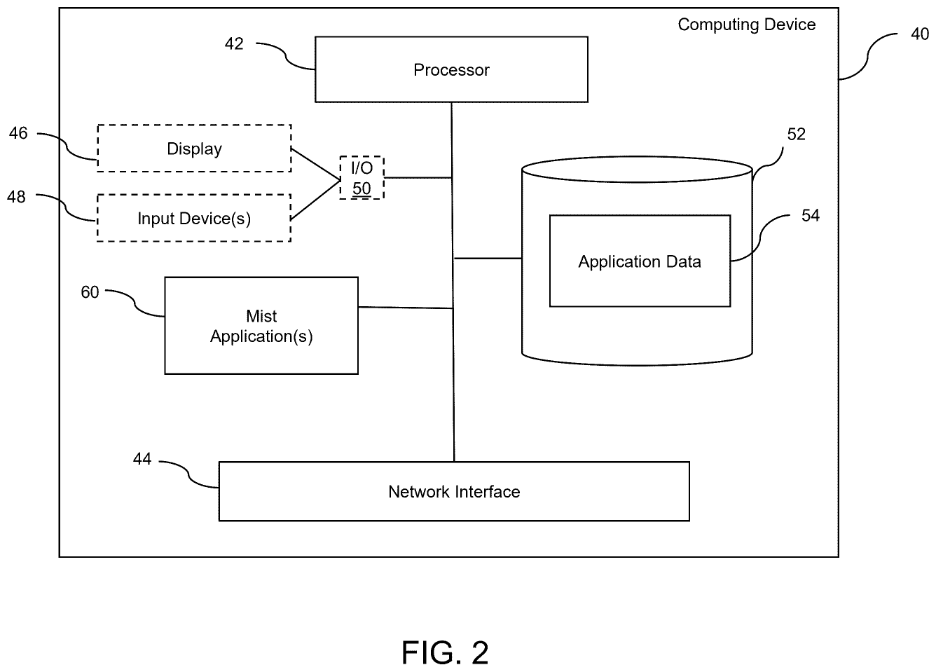

It can be appreciated that the distributed training system 12 may be running on one or more computing devices 40 (e.g., see FIG. 2). Such computing devices 40 (or computing systems) may include, but are not limited to, a personal (e.g., desktop) computer, a server computer or other computing system that is equally or more powerful or otherwise suitably adapted to running computer code, e.g., for use with machine learning (such as LLMs) and/or other applications.

The distributed training system 12 may be hosted or otherwise run on the one or more computing devices 40 or may be accessed by the computing device(s) 40 over a communication network (not shown). Such communication network(s) may include the Internet, accessed via, for example, a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). The distributed training system 12 may be embodied in an application, which may take the form of a mobile-type application (also referred to as an “app”), a desktop-type application, an embedded application in customized computing systems, or an instance or page contained and provided within a web/Internet browser, to name a few.

The models 16 and/or input data 18 may be provided to the distributed training system 12 by a separate one or more computing devices 40 or computing system, by a separate entity or may be integrated with a system or application running Mist 14 within the same computing device(s) 40 or computing system. As such, the configuration shown in FIG. 1 is illustrative and other computing device/system configurations are possible. For example, the computing environment 10 shown in FIG. 1 may represent a single device or the integration/cooperation of multiple electronic devices such as a client device and server device or a client device and a remote or offsite storage or processing entity or service or multiple client or server devices working together in performing distributed training. That is, the computing environment 10 may be implemented using any one or more electronic devices including standalone devices and those connected to offsite storage and processing operations (e.g., via cloud-based computing storage and processing facilities).

FIG. 2 shows an example of one such computing device 40, e.g., from a set of one or more computing devices 40, which may be utilized by any one or more of the entities shown in FIG. 1, for example, a personal electronic device or server used to provide the optimizations performed by Mist 14 within the distributed training system 12. The computing device 40 in FIG. 2 may provide an example of a device on which upstream and/or downstream application(s)—not shown, may be deployed (e.g., systems providing the input data 18, model 16 or consuming the trained model 20, etc.).

In this example, the computing device 40 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device(s) 40 may also include one or more Mist-related applications 60 (e.g., as shown in FIG. 3 and described in more detail below), a data store 52, and client application data 54. The data store 52 may represent a database or library or other computer-readable medium configured to store data and permit retrieval of data by the computing device 40. The data store 52 may be read-only or may permit modifications to the data. The data store 52 may also store both read-only and write accessible data in the same memory allocation. In this example, the data store 52 stores the application data 54 for the Mist application(s) 60 that is/are configured to be executed by the computing device 40 for a particular role or purpose.

While not delineated in FIG. 2, the computing device(s) 40 include(s) at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 2 illustrates examples of modules and applications stored in memory on the computing device 40 and executed by the processor(s) 42.

It can be appreciated that any of the modules and applications shown in FIG. 2 may be hosted externally and may be available to the computing device 40, e.g., via a network interface 44. The data store 52 in this example stores, among other things, the application data 54 that can be accessed and utilized by an application on that device such as the Mist application(s) 60. The data store 52 may additionally store one or more software functions or routines in a cache or in other types of memory.

As shown in FIG. 2, the computing device(s) 40 may, optionally (e.g., when configured as a personal electronic device such as a smartphone or tablet), include a display 46 and one or more input device(s) 48 that may be utilized via an input/output (I/O) module 50. That is, such components may be omitted when the computing device 40 does not interact with a user.

The application(s) 60 may receive one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 40.

### 2. Background and Motivation

Large DL models, especially LLMs, such as GPT-3 [8, 63] and LLaMa [25, 77, 78], are found to require excessive computation and memory, leading to significant costs, energy consumption, and carbon emission [24, 49]. Consequently, distributed training, i.e., scaling hardware and splitting the DL model and/or the input data, is the typical solution to train emerging LLMs [67, 72]. The memory footprint needed in distributed training can be categorized into three types: i) model states including parameters, gradients, and optimizer states, ii) saved activations that are stashed in the forward pass and used for the backward computation, and iii) intermediate tensors.

### 2.1 Optimizations in Distributed Training

Current distributed training optimization techniques mainly involve parallelism and GPU memory footprint reduction approaches. Parallelism is mostly designed for scaling the training on multiple devices [1, 20, 35, 42]. However, as DL models grow in size and exceed the memory capacity of a single GPU, the role of parallelism in partitioning the DL model becomes increasingly important [34, 65, 72]. Moreover, memory footprint reduction techniques, such as activation checkpointing [17, 37, 39, 86] and offloading [27, 30, 60, 69], are important to alleviate the memory pressure of large-scale model training and can potentially improve training performance.

Data Parallelism. To scale training, data parallelism [1, 42] distributes input data across GPUs, with each GPU processing its data independently using a model replica. It involves only an all-reduce of gradients per iteration but requires the entire model to fit within each GPU's memory.

Sharded Data Parallelism. Sharded data parallelism (SDP) (also known as Zero Redundancy Optimizer (ZeRO) [65, 66, 68, 85]) reduce redundant model replicas by performing gather and reduce-scatter communication operations on model states as needed.

Tensor Parallelism. Tensor parallelism (TP) [54, 72] also partitions the model vertically. Different from SDP which communicates the model states, TP conducts multiple all-reduce over output activations in the forward pass and input gradients in the backward pass to maintain compute correctness.

Pipeline Parallelism. Pipeline parallelism (PP) [26, 34, 38, 43, 52, 53] implements horizontal partitioning, segmenting the model into stages. Although it only involves small communication overhead to transfer intermediate tensors, the dependency between stages introduces pipeline bubbles, which causes efficiency to suffer as a result of the idle time.

Activation Checkpointing. Activation checkpointing (CKPT) (also known as recomputation) [3, 17, 37, 39, 86] discards certain activations in the forward pass, while stashing others. Later in the backward pass, the discarded activations are recomputed from the stashed activations, and are then used for gradient computation. This method reduces the memory needed for the saved activations, at the cost of recomputing discarded activations in the backward pass.

Offloading. Offloading [27, 30, 60, 66, 69, 79](also known as swapping) involves transferring some model states or activations from the GPU device to the host CPU to mitigate the peak memory usage and swap tensors back to GPU devices when they are needed, alleviating the memory pressure. The efficiency of swapping significantly depends on pre-fetching and overlapping, allowing memory transfers to be orchestrated outside the critical path.

### 2.2 Existing Distributed Training Systems

The optimization problem of distributed training can be formulated as: given the DL model and input data, choose the best optimization combination to maximize the training performance under the constraint that the memory footprint of the partitioned training process needs to fit in the available memory of each GPU device (henceforth referred to as memory constraint). To efficiently train a large model, distributed training systems apply different parallelism and memory footprint reduction techniques.

Manual combination of these techniques. Megatron-LM [40, 54, 72] and DeepSpeed [65, 68] are therefore proposed, providing various parallelism and some coarse-grained memory footprint optimizations. They remain highly performant and are the common choices of the practical pretraining tasks due to its flexibility and good extensibility to other techniques such as advanced kernels [18, 19] and communication-computation overlap [81]. However, their performance is not guaranteed as users have to manually select and combine the provided optimizations, which can be difficult, even for experienced users.

Automatic tuning for distributed training. Many prior works including Tofu [80], FlexFlow [48], TensorOpt [9], Piper [76], Merak [41], Alpa [87], Galvatron [50] are proposed, automatically finding the best-performing combination of parallelism approaches. Some recent efforts including Aceso [45], Slapo [12], and AdaPipe [75] try to tune some memory footprint reduction techniques with certain parallelism to achieve better performance.

As shown in part (a) of FIG. 3b, without memory optimization, all parallelism plans result in out-of-memory (OOM) errors. In part (b) of FIG. 3b, applying full CKPT (all layers being recomputed, as in Megatron-LM and Alpa) reduces memory usage by recomputing activations, avoiding OOM. The best parallelism strategy found is DP=2, PP=2, b=1. In part (c) of FIG. 3b, if activation checkpointing is tuned (as in Aceso and Adapipe), the number of recomputed layers is reduced from 16 to 8 on the first two GPUs, and from 16 to 0 on the other two, reducing recomputation. During tuning, although another strategy (DP=1, PP=4, b=1) fully eliminates recomputation by using the extra memory from the increased PP size, the added pipeline bubbles outweigh the benefits of reduced recomputation, causing it to under-perform compared to PP=2. In part (d) of FIG. 3b, tuning ZeRO (as in DeepSpeed [68]) enables DP=4, PP=1, b=2 with ZeRO-2, preventing OOM by sharding gradients. Similarly, in part (e) of FIG. 3b, tuning offloading enables the same parallelism with an optimizer offloading ratio of 0.325, avoiding OOM. In both cases, reduced pipeline bubbles and improved kernel efficiency (from the increased batch size) outweigh the memory optimization overhead, increasing training efficiency. These examples show that tuning each memory optimization with parallelism improves training performance, achieving speedups of 1.22×, 1.25× and 1.16× for CKPT, ZeRO, and offloading tuning, respective, compared to the full CKPT strategy.

Building upon these findings, Mist can be configured to co-optimize all memory optimizations with parallelism and identify an even better strategy: DP=4, PP=1, b=2 with ZeRO-2 and adjusted activation checkpointing (recomputed layers reduced from 32 to 28), which reduces pipeline bubbles (compared to activation checkpointing tuning only) and recomputation (compared to ZeRO tuning only), leading to a 1.30× speedup while maintaining memory savings.

To further demonstrate the benefits of comprehensive co-optimization, one may consider an example of training GPT-3-7B on eight NVIDIA L4 GPUs with a global batch size of 512. When only activation checkpointing is tuned, the best parallelism strategy identified is DP=1, PP=8, b=1, which causes severe pipeline imbalance and hardware idling, as shown in part (a) of FIG. 3c. However, by comprehensively co-optimizing all techniques, one may find a better strategy: DP=2, PP=4, b=2, with adjusted activation checkpointing and optimized offloading ratios, detailed in part (b) of FIG. 3c, where 00 and AO stand for optimizer and activation offloading, respectively. This configuration uses offloading to gain GPU memory, which is then used to reduce PP size from 8 to 4 and eliminate recomputation for the last two stages. As shown in part (c) of FIG. 3c, co-optimization reduces pipeline stages and device idle time, improving overall performance despite some offloading overhead, as the optimizer offloading overhead is amortized over multiple micro-batches and activation offloading can overlap with computation. Comprehensive co-optimization yields a 1.22× speedup over tuning only parallelism and a 1.11× speedup over tuning parallelism with activation checkpointing, demonstrating significant performance gains.

However, existing systems lack support for comprehensive co-optimization. For instance, Aceso does not support ZeRO or offloading, Slapo only tunes activation checkpointing within a fixed parallelism plan, and AdaPipe focuses solely on pipeline parallelism and activation checkpointing. It limits their ability to fully leverage the trade-offs between memory reduction and runtime overhead, leading to suboptimal performance.

### 2.3 Shortcomings of Existing Frameworks

However, the present disclosure identifies several key shortcomings of the existing distributed training frameworks.

Shortcoming #1: Unable to comprehensively co-optimize memory optimizations with parallelism. As shown in Table 1, prior automatic distributed training systems either focus on tuning parallelism and have to rely on manually selected memory optimizations before parallelization tuning [48, 50, 87], or only co-optimize partial memory footprint reduction techniques with certain parallelisms [12, 45, 75]. For instance, Slapo [12] is limited to tuning activation checkpointing within a fixed parallelization plan, Aceso [45] does not support sharded data parallelism or offloading, and AdaPipe [75] only focuses on the combination of pipeline parallelism and activation checkpointing.

One question asks the importance of comprehensively co-optimizing memory optimizations (CKPT and offloading) with parallelism (DP, SDP, TP, and PP). In reply, one may consider that all of them involve trade-offs between memory footprint and extra communication or computation overhead [17, 60, 65, 72]. To fit the distributed training in each worker, a certain amount of memory footprint reduction is required, by a combination of memory optimizations and parallelism. Only when all optimizations are tuned together, the minimal overhead can be achieved. As shown in Table 4, when training a GPT model with 7B parameters on 8 NVIDIA L4 GPUs, only tuning parallelization leads to 49.09 seconds per iteration, while tuning parallelism with memory optimizations reduces the runtime to 40.27 seconds, resulting in 1.22× speedup. The speedup comes from a compound effect of (1) memory footprint reduction from the optimizer and activation offloading, (2) computation reduction from fewer layers being recomputed, (3) better computation communication overlap from batch size tuning, and (4) a more balanced pipeline partitioning (see, for example, Section 5.7 below).

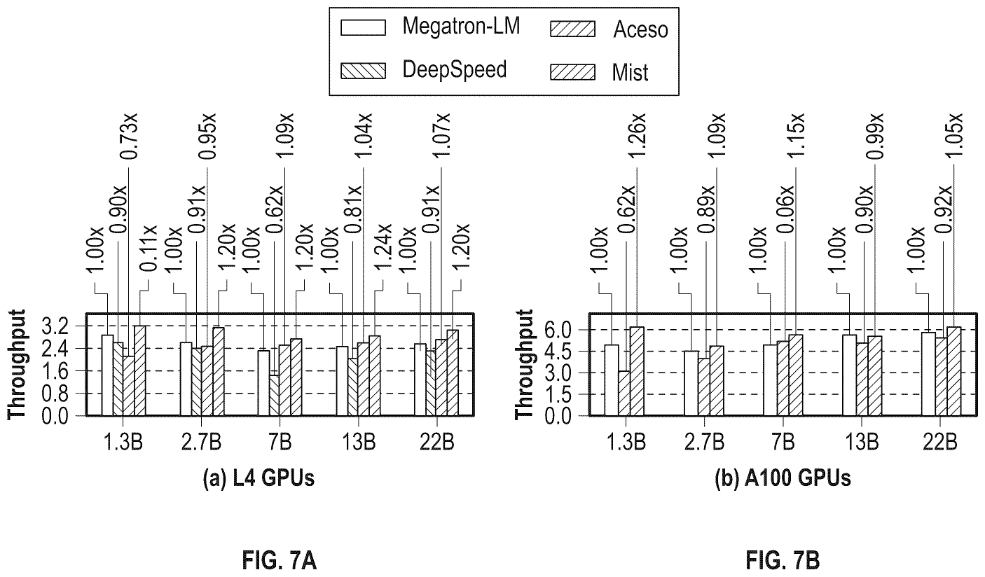

Shortcoming #2: Not overlap-aware beyond basic gradient synchronization overlap. Computation-communication overlap has been widely explored to accelerate distributed training [11, 59, 60, 65, 72, 81, 85]. However, existing automatic distributed training methods are found to fail to consider the advanced overlapping opportunities beyond basic gradient synchronization overlap. This results in significant performance degradation, as seen in experiments where Aceso underperforms manual implementation Megatron-LM (with overlap) in 6 out of 10 cases despite a larger search space (see FIG. 7a). Moreover, techniques like ZeRO and offloading add extra communication overheads, requiring overlap with computation or pipeline bubbles to maintain efficiency. In part (b) of FIG. 3c, Stage 2 shows a 13% overhead if activation offloading is not overlapped, and for Stage 3, offloading optimizer states for a 7B model with a PP=4 takes 7 seconds, resulting in a 40% overhead with a batch size of 64. Additionally, computation-communication interference results in inaccurate performance predictions. For instance, one may observe a 7.7% performance degradation for the linear layer in attention module of the motivational example when it is executed concurrently with all-reduce operations, which becomes worse when CPU-GPU communication is also involved. Ignoring overlap leads to mis-estimating optimization configurations and results in sub-optimal strategies Additionally, sharded data parallelism and offloading need to rematerialize partial tensors, which can be pre-fetched and overlapped with the computation to mitigate the communication overhead [60, 65, 66, 85]. The nature of pipeline parallelism also provides overlap opportunities that non-first stages can hide the re-materialization costs if they are independent of previous stages. [61, 72]. Not being overlap-aware leads to the underestimation of the performance of certain optimizations that can be overlapped and results in sub-optimal strategies.

Nevertheless, taking the case study provided herein as an example, one can find two key insights: i) the enlarged batch size increases the computation time and thus effectively hide the communication overhead, ii) all pipeline stages except the first one prefer optimizer offloading over activation offloading. If the automatic distributed system is not overlap-aware, such critical optimization opportunities could be overlooked.

Shortcoming #3: Unable to navigate the exploded search space. Co-optimizing memory footprint reduction techniques with parallelism significantly expands the search space, making it difficult to efficiently find the best combination. For example, Alpa takes over 40 hours to find the best parallelization strategy for GPT-3-39B on 64 GPUs [89]. As depicted in FIG. 3d, simultaneously tuning parallelism and memory optimizations further dramatically increases the search space and complexity. Even after applying search space pruning methods, such as inter and intra-stage tuning decoupling, the search space remains significantly larger than what existing performance predictors can efficiently handle. For example, Proteus, a fast imulation-based tool that supports the prediction of performance in parallelization and recomputation, requires around 6 seconds to simulate one optimization configuration for GPT-2 on 32 GPUs [21]. Despite its speed, this kind of tool is still considered impractical for effectively exploring the vast search space presented by the presently explored problem.

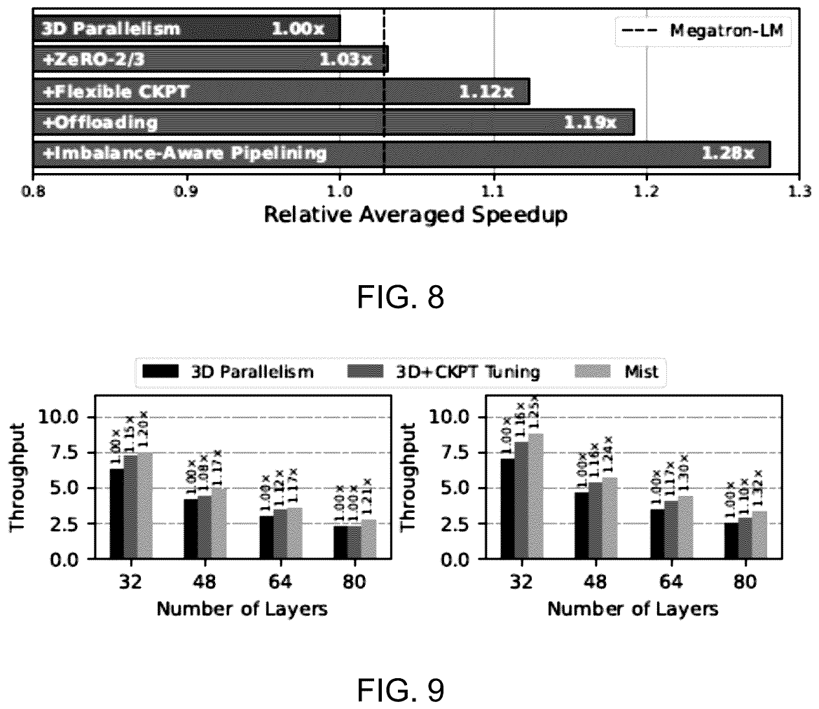

Shortcoming #4: Not inter-microbatch imbalance-aware in pipeline parallelism. Automatic parallelism planners [45, 87] are able to find to best pipeline partition, indicating their inter-stage imbalance-awareness. To efficiently tune the pipeline parallelism, these methods use the averaged microbatch time to represent the pipeline stage time and estimate the end-to-end training time accordingly, implicitly assuming that all microbatches within a pipeline stage are the same [45, 87]. However, it has been found that the first and the last microbatch consume more time since they may need extra operations for parameter all-gathering, gradient reducescattering, and optimizer offloading. For example, in the case study one can show, simply averaging the microbatch time leads to 6.87% error ratio for end-to-end performance prediction, which may cause up to doubled performance slowdown during tuning. As FIG. 8 shows, ignoring the inter-microbatch imbalance leads to about 9% slowdown compared to the optimal solutions.

### 3. Mist: Overview

An important design challenge of memory footprint reduction techniques and parallelism co-optimization is the exploded number of combinations. For example, the single device activation checkpointing planner Checkmate [37] could not find any feasible solution within 6 hours [36] in at least one attempt. Automatically finding the best parallelization strategy with fixed gradient accumulation steps for a GPT3-39B [8] on 64 GPUs via Alpa naively would take more than 40 hours [87]. Tuning the best strategy of both introduces even larger search space and higher complexity. To address these shortcomings and design challenges, the present disclosure introduces Mist, a memory, overlap, and imbalance-aware distributed training system that co-optimizes memory optimizations with parallelism to maximize the throughput under memory constraint. An important insight behind Mist is to orchestrate different optimizations together to make the best use of all system resources and strike the best trade-off among computation, communication, and memory footprint.

Mist resolves the Shortcomings #1-3 and the design challenge using three key components:

(1) an overlap-centric schedule template that determines the granularity and order of how various techniques are applied upon the model. It mitigates the tuning complexity issue by introducing appropriate heuristics, and addresses Shortcoming #2 by orchestrating optimizations in an overlapped manner.

(2) an interference-aware symbolic analysis system that provides accurate and efficient predictions of the symbolic runtime and memory usage expressions, considering the interference from the overlapped operations. To achieve efficient predictions, Mist only runs a single simulation pass for optimizations represented as symbols, and outputs the symbolic expressions or functions of the system metrics. To provide accurate prediction involving multiple optimizations, Mist develops an interference-aware performance model, helping to address Shortcoming #2.

(3) an imbalance-aware hierarchical auto-tuner that decouples the tuning into an inter-stage imbalance-aware MILP problem to address Shortcoming #3 and an intra-stage Constrained Optimization problem, employing an off-the-shelf solver [28] and batched value evaluations to efficiently determine the best configuration, respectively.

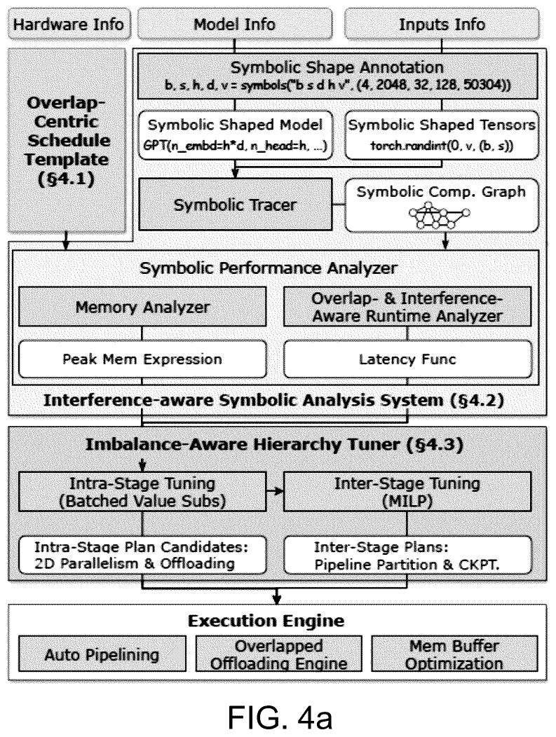

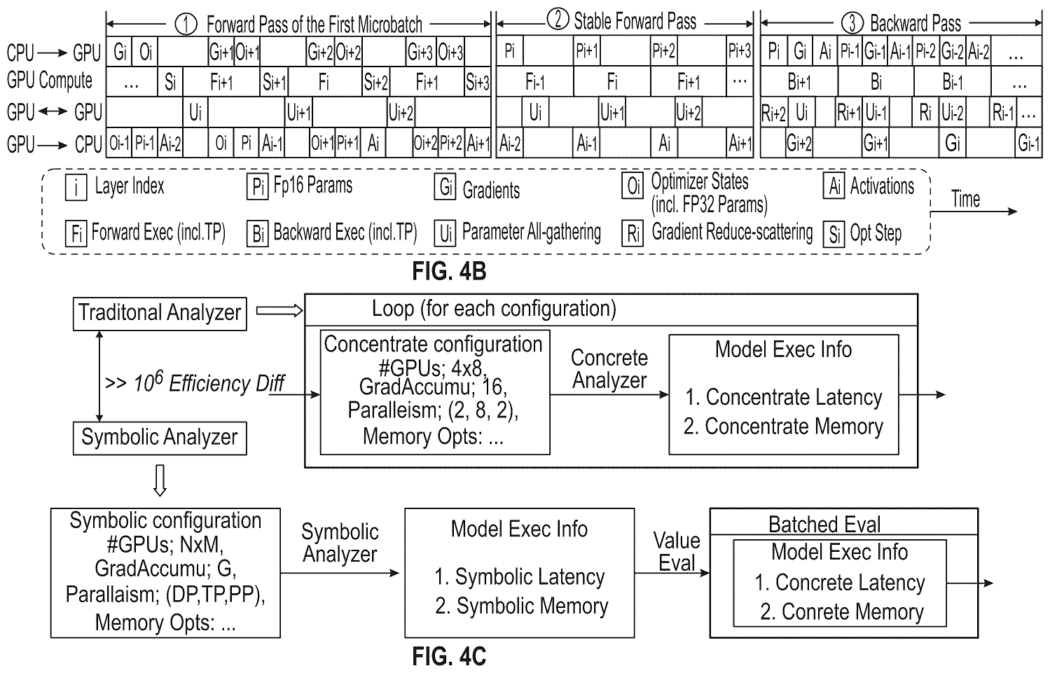

As FIG. 4a shows, given a model and its input data, they are annotated with symbolic shapes and traced by a tracer to get the symbolic shaped computational graph. The symbolic computational graph, on top of the Overlap-Centric Schedule template, is analyzed by a symbolic performance analyzer to derive the peak memory expression and runtime function whose inputs are optimization-related symbols. To effectively tune the best strategy, Mist decouples the tuning into inter-stage and intra-stage tuning. During intra-stage tuning, Mist evaluates the symbolic memory expression and runtime function with concrete optimization values in a batched way to find a pareto-optimal series of 2D parallelism and offloading plans for each potential inter-stage candidates. In the inter-stage tuning phase, Mist addresses the inter-stage and inter-microbatch imbalances inherent in pipeline parallelism, proposes to consider stable microbatch time T_{stable} (or tᵢ) and its deviation from the first and last microbatch T_{delta} (or dᵢ) and formulates the problem as a MILP problem, to find the best pipeline partitioning and activation checkpointing plans. Mist also provides an orchestrated execution engine to execute the found plans.

### 4. Mist: Design Details

### 4.1 Overlap-Centric Schedule Template

To accurately analyze and efficiently tune the best combination of various optimizations, the system uses a unified schedule template to determine order and granularity of how parallelism and memory optimizations are applied upon the DL model. There are two design objectives for this schedule template. First, to facilitate feasible tuning, optimization representation and granularity should be carefully designed to balance the optimization effectiveness and search space. Second, to fully utilize hardware resources and mitigate the runtime overhead of various techniques, the schedule template needs to enhance the overlap opportunities.

Optimizations and Granularity. Mist comprehensively supports various parallelism techniques such as DP [1, 42], SDP [65, 85], TP [54, 72], and PP [34, 52], alongside memory optimizations like fine-grained swapping [60, 69] and flexible activation checkpointing [17, 37, 39], as shown in Table 1. In the schedule template, 2D parallelism is represented as integers to denote the parallel sizes and pipeline parallelism is represented as sequences of tuples to denote the layer and device partitions. Swapping strategies are floating-point values, representing ratios of certain types of memory (parameter, gradient, optimizer states, and activation) to be offloaded, and activation checkpointing is represented as integers to denote the layers being recomputed.

To balance the optimization effectiveness and search space, Mist adopts the stage-wise tuning granularity, meaning that all layers (e.g. Transformer Layers) within the same pipeline stage use the same parallelism and layer-wise offloading ratios. Theoretically, each potential operator grouping can have a distinct group of optimizations with different parallelism and memory optimization configurations. However, for workloads Mist mainly targets, for example, large scale DL models, the module architecture of different layers are usually similar [8, 77], providing opportunities to prune the search space. Additionally, offloading is applied layer-wise with uniform offloading ratios for all layers within the same stage, reducing the search space while maintaining a fine-grained control to cover optimal overlap.

Mist can adopt stage-wise tuning granularity, meaning all layers within the same pipeline stage use the same parallelism and memory optimization configurations to balance optimization effectiveness and search space. Specifically, for gradient accumulation steps G and the number of pipeline stages S, the combination of (Li, bi, DPi, TPi, ZeROi, CKPTi, WOi, GOi, OOi, AOi) defines the configuration for pipeline stage i (see Table 2 below for detailed explanations of the symbols). Notably, swapping strategies are represented as floating-point ratios, enabling fine-grained control of memory offloading and enhancing computation-communication overlap potential.

TABLE 2
Optimization variables in the schedule template.

| Name | Value Type | Meaning |
|---|---|---|
| G | Integer | Gradient accumulation steps |
| S | Integer | Number of pipeline stages |
| Lᵢ | Integer | Number of layers in stage i |
| bᵢ | Integer | Micro batch size for stage i |
| DPᵢ | Integer | DP size for stage i |
| TPᵢ | Integer | TP size for stage i |
| ZeROᵢ | One-Hot [0-3] | ZeRO level for stage i |
| CKPTᵢ | Integer | Number of recomputed layers for stage i |
| WOᵢ | Float [0, 1] | Weight offloading ratio for stage i |
| GOᵢ | Float [0, 1] | Gradient offloading ratio for stage i |
| OOᵢ | Float [0, 1] | Opt states offloading ratio for stage i |
| AOᵢ | Float [0, 1] | Activation offloading ratio for stage i |

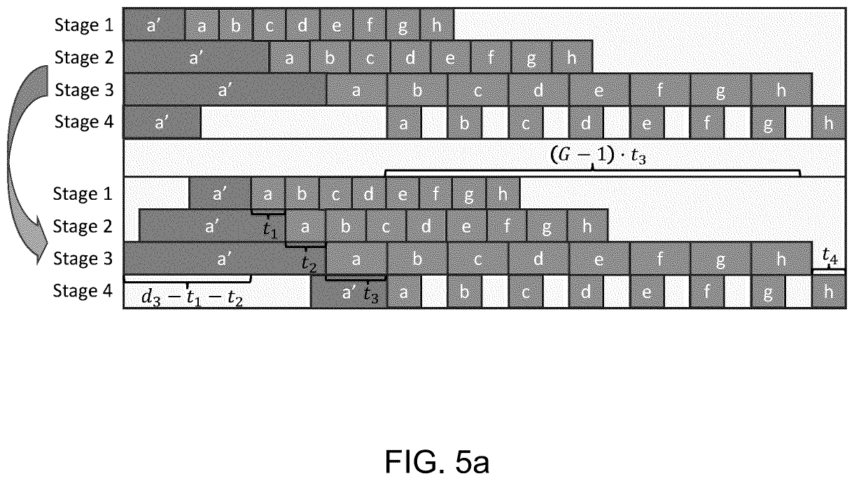

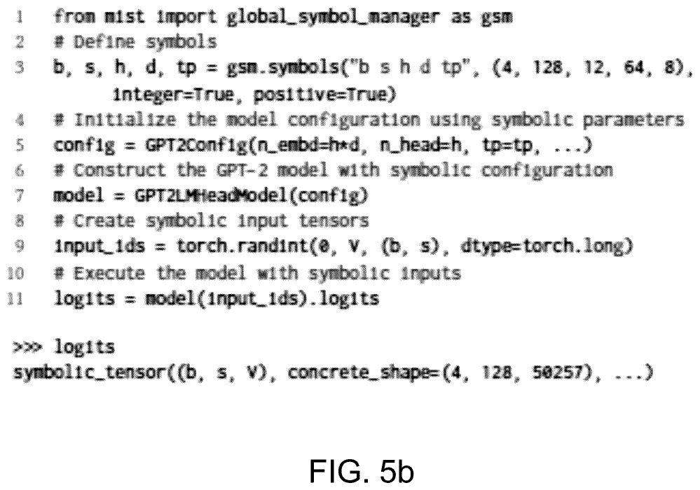

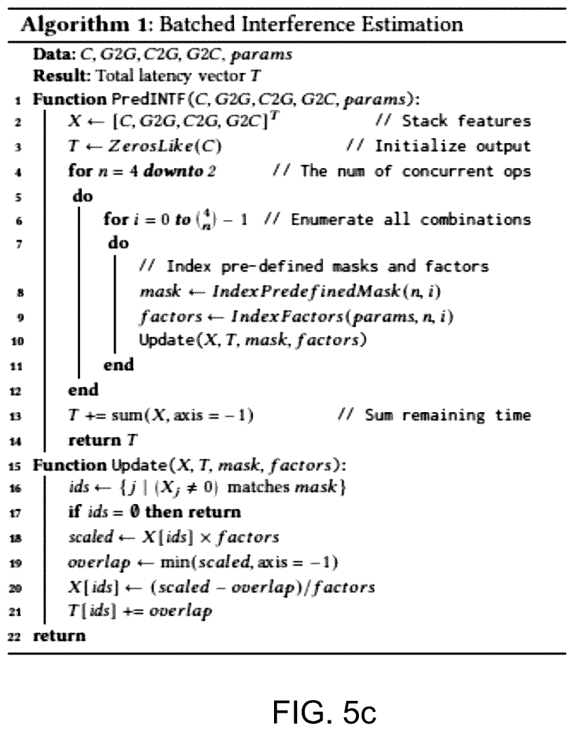

Overlapped Schedule. The motivation behind designing an overlapped schedule is to better utilize computational units and memory bandwidths across various communication channels simultaneously, while maintaining low GPU memory footprint. As shown in FIG. 4b, computation, GPU↔GPU communication, and CPU-GPU communication are overlapped. As shown [symbol] , during the forward pass, the computation of layer k overlaps with the activation swapping out of layer k−1, and the swapping-in and all-gathering of parameters for layer k+1. Similarly, as shown in [symbol] , in the backward pass, the computation of layer k overlaps with the gradient reduction and the swapping-out of the previous backward layer k+1, along with the swapping-in of parameters, gradients and activations, and all-gathering of parameters for the next layer k−1. This overlap ensures that the computation in layer k is not stalled by data movement or pre-fetching, leading to better hardware utilization. Apart from the intra-stage overlap, the schedule template also supports inter-stage overlap: that is, hide the communications that are independent of previous stages in the pipeline bubbles, as shown in FIG. 5a.

Optimizer Step Decoupling and Repositioning. It has been found that a monolithic optimizer step in current DNN training process can be problematic in cases where sharded parallelism and swapping are applied. Specifically, one may make two observations: First, the peak memory may shift to the optimizer step phase. To perform an optimizer step in with mixed precision, the following tensors should be in device memory at the same time: FP16 parameters, FP16 gradients, FP32 optimizer states, and FP32 master parameters [65]. In the case where swapping is applied, the peak memory in the optimizer step phase may exceed that of the backward pass, since there are at most two layers' states fully in the GPU memory during forward and backward computation, while the states of other layers are only partially in GPU memory. Second, redundant communication overhead increases. In the optimizer step, all states are rematerialized either through swapping, all-gathering, or both. These operations also occur during the forward and backward passes.

Different from the traditional training process, Mist proposes to decouple the optimizer step to multiple optimizer steps and reposition the optimizer step of each layer right before the first forward step or immediately after the last backward step of that layer. As shown in FIG. 4b, Mist chooses the former design, due to the fact that the memory pressure of the first forward pass would be much lower than that of the last backward pass, as fewer activations are saved.

### 4.2 Symbolic-Based Efficient Performance Analysis System

Due to the exploded number of combinations when memory footprint reduction techniques and parallelism are co-optimized, it is difficult if not impossible to benchmark each optimization combination during tuning, necessitating accurate and efficient performance prediction. This leads to two design objectives for the performance predictor. First, to traverse through the huge search space, it should be highly efficient. Second, to give a good estimation during tuning, it should be accurate when various optimizations and complicated computation-communication interference are involved. Performance modeling is important for optimizing distributed training as it enables efficient configuration exploration. Existing systems rely on simulation-based performance prediction, running a concrete simulation for each configuration to estimate computation, communication, and memory usage. As shown in FIG. 4c, a traditional simulator initializes a GPT model with a concrete parallelism configuration of e.g., (DP=2, TP=8, PP=2) on 32 GPUs, applies memory optimizations, and simulates execution to measure performance and peak memory usage. Although each simulation is efficient, it still takes about 6 seconds per configuration [21]. This cost makes exhaustive search impractical for our combined search space. One may now demonstrate how Mist's symbolic-based performance analysis helps to accelerate the performance prediction and thus facilitates the traversal over a huge search space. This section first introduces a symbolic analysis system that addresses the efficiency issue, followed by interference aware performance modeling to address the accuracy issue.

### 4.2.1 Symbolic Analysis System

The Mist symbolic analysis system uses symbolic models, input data, and optimization variables to predict runtime and memory usage in the form of symbolic expressions or functions, instead of concrete ones. Traditional methods, whether running-and-profiling-based or static-analysis-based, predict performance based on a DL model with a specific optimization combination [23, 33, 47, 70, 83]. For example, Proteus, a fast simulation-based tool that supports prediction of performance in parallelization and recomputation, requires around 6 seconds to perform a simulation for GPT-2 on 32 GPUs for a single parallelism strategy [23], making it unable to effectively find the best strategy in the present search space. Unlike traditional performance predictors, Mist only needs a single pass of simulation on the symbolic model and optimizations, and the predictions afterwards are simplified to batched value substitutions, which are very efficient.

Mist proposes a symbolic analysis system for LLMs, supporting symbolic execution, tracing, and analysis. As shown in FIG. 5b, users define the model and inputs, simply replacing the concrete dimensions and optimizations with symbols. Then all operations are executed with the information of symbolic shapes. On top of it, Mist traces the computational graph and performs static analysis to derive symbolic expressions for execution time and memory usage. Instead of repeatedly simulating different configurations, Mist only performs a single symbolic simulation pass and later substitutes values into these expressions to quickly evaluate different configurations. This approach enables batched evaluation and compilation optimization, making performance prediction over 105× faster than traditional analyzers.

As FIG. 4a shows, model, input data, and optimization information are annotated by a symbolic shape annotation system, converted into corresponding representations with symbols as their scalar values or shapes. The executor supports symbolic execution to propagate the symbolic shapes into all the model intermediate activations and gradients. Based on this, Mist provides a symbolic tracer which traces the training execution into a symbolic computational graph, where each node consists of an operator with symbolic shaped tensors as arguments and outputs.

Memory Analyzer. Mist adopts the liveness-analysis-based method to predict the memory usage of a given model with symbolically parameterized optimizations. Specifically, Mist runs a simulation upon the symbolic computational graph only once, and records the live tensors for each timestamp. The peak memory usage is the maximum memory of all live tensors when executing each node. To facilitate the hierarchical tuner, which means number of layers are changeable due to the pipeline partitioning, the memory analyzer in Mist includes an intra-layer memory analysis pass and an inter-layer memory analysis pass. The intra-layer memory analysis pass is used to output the layer memory statistics (memory of layer states and saved activations, and peak activation memory usage inside the layer execution). The interlayer memory analysis pass assumes that the saved tensors and intermediate activations from one layer do not overlap with those from another, except the outputs of previous layer serve as the inputs to the next layer, and calculate the peak memory usage by combining the memory statistics from the intra-layer memory analysis The outputs, memory statistics and peak memory usage, are all symbolic expressions with optimization and model-related symbols.

Runtime Analyzer. Different from memory analysis, runtime cannot be easily represented as the symbolic expressions due to the complex performance characteristics of operators. However, runtime calculation is straightforward using profiling and summation if there is no overlap. Communications can still be modeled symbolically using an alpha-beta model. For computation, maintain a compute operator database, benchmarking new operators or new input shapes on the current hardware and recording the results on-the-fly during the intra-stage tuning. These performance numbers can be reused for future queries.

That is, for runtime analysis, direct symbolic representation is impractical due to the complex behavior of various GPU kernels. Instead, Mist profiles operator execution dynamically. Computation is estimated using a operator computation database, which benchmarks new operators or unseen input shapes on the current hardware and stores results for future use. Communication is modeled symbolically by dividing communicated bytes by the bandwidth, and overlap is managed via interference modeling, which is discussed further below. The design of the symbolic analysis system addresses several significant challenges, making it both powerful and widely applicable. First, large models are run across multiple GPUs due to memory capacity issues, but direct analysis on multi-GPU setups is inefficient. This may be solved by using the idea of fake tensors and meta devices, where tensor shapes are represented symbolically but not materialized physically, allowing analysis without needing actual hardware. Second, backward pass memory analysis is difficult due to the absence of an explicit computational graph. One may generate a fake backward graph using gradient function properties to track memory during backpropagation. Third, supporting custom kernels like FlashAttention and communication operations required custom symbolic representations, ensuring flexibility. Beyond optimization, the present symbolic analysis system offers clear insights into workloads, making it easier to understand how specific parameters and optimizations affect performance, which can be valuable for both practical use and educational purposes.

### 4.2.2 Interference Model

Runtime prediction is much challenging when overlap is involved. In extreme cases, computation, NCCL (GPU↔GPU Communication) kernels, D2H (GPU→CPU communication) kernels and H2D (CPU→GPU communication) kernels may run simultaneously, thus an interference model is essential to accurately estimate the end-to-end runtime. Mist provides an interference model that predicts the impact of running up to four different types of kernels simultaneously (computation, NCCL, D2H, and H2D kernels). Instead of using machine learning models like XGBoost [15], which are prone to overfitting in this case, the system adopts a mathematical model that has been developed with fewer parameters and clear natural intuition. Parameters are set for each possible combination of co-running kernels, representing the corresponding slowdown for each participant. Mist iteratively applies slowdown factors to each overlapped segment, calculates the overlap, and updates the remaining segments, reducing the number of overlapped components until only single component is left. The system utilizes a data-driven approach to fit the model, where different shapes and combinations of concurrent kernels are sampled and benchmarked, and the resulting runtime data are used to train the slowdown factors.

Algorithm 1, shown in FIG. 5c, implements batched interference estimation, which iteratively applies slowdown factors to update execution times. For each concurrency level (n=4 to 2 operations), it iterates through all

$$( \begin{matrix}4 \\ n\end{matrix} )$$

combinations, retrieves predefined masks and factors, and invokes Update. The Update f fifirscales execution time by their respective slowdown factors, computes the scaled overlapping, and updates remaining execution times accordingly. By progressively resolving interference through successive reductions, the algorithm eliminates concurrent operations until only a single component remains.

A data-driven approach is used to fit the model, where different shapes and combinations of concurrent kernels are sampled and benchmarked, and the resulting runtime data is used to train the slowdown factors.

### 4.3 Imbalance-Aware Hierarchical Auto-Tuner

Given a model, a global batch size B, a device mesh (N,M), Mist's auto-tuner outputs the best training plan including the gradient accumulation steps G, layer partitions and device assignments for different pipeline stages, and (DP, TP) sizes and memory optimization plans for each stage. To efficiently find the best strategy in the huge search space, Mist adopts the similar high-level idea of hierarchical tuning, decoupling the whole tuning process into intra-stage tuning and inter-stage tuning [87]. Intra-stage tuning aims at finding the best optimization plans for all layers within the same stage, while inter-stage tuning is for the best stage partitioning and device assignment. Compared to previous automatic parallelization methods, Mist offers two key improvements: imbalance-awareness in the inter-stage tuning and memory-awareness in the intra-stage tuning.

### 4.3.1 Inter-Stage Tuning

Inter-stage tuning finds the best layer partition and device assignment, as well as the corresponding best number of layers being recomputed. As FIG. 5a shows, Mist considers the inter-microbatch imbalance and proposes a new objective as

$${min}_{{1 \leq i \leq S}_{{l}_{i} , {c}_{i} , ( {n}_{i} , {m}_{i} )}} \{ ( G - 1 ) \cdot {max}_{1 \leq i \leq S} \{ {t}_{i} \} + {\sum }_{i = 1}^{S} {t}_{i} + {max}_{1 \leq i \leq S} ( {d}_{i} - {\sum }_{1 \leq j \leq i} {t}_{i} ) \} \qquad ( 1 )$$

where S means the number of stages, l denotes the layer partition, c denotes the number of checkpointed layers, and (n,m) denotes the device assignment. For simplicity, one may define any microbatch that is neither first nor last as a stable microbatch. tᵢ means the stable microbatch runtime of stage i, and dᵢ means the runtime delta of the first and last microbatches compared to tᵢ. The first term ensures that Mist correctly identifies the pipeline bottleneck, while the second and third terms address inter-stage and inter-microbatch imbalances, respectively. The third term also considers the overlap opportunities of hiding communication independent of previous stages in the pipeline bubbles.

Objective 1 can be solved given (tᵢ, dᵢ) according to lᵢ, cᵢ, and (nᵢ, mᵢ). However, tᵢ and dᵢ are correlated within a stage. For instance, if optimizer offloading is applied aggressively, the runtime of the first microbatch significantly increases and the runtime of the stable microbatches reduces because of the less intensive memory pressure. This suggests that (tᵢ, dᵢ) are of pairs in a pareto frontier inside the stage.

$${min}_{{1 \leq i \leq S}_{{l}_{i} , {f}_{i} , ( {n}_{i} , {m}_{i} )}} \{ ( G - 1 ) \cdot {max}_{1 \leq i \leq S} \{ {t}_{i} \} + {\sum }_{i = 1}^{S} {t}_{i} + {max}_{1 \leq i \leq S} ( {d}_{i} - {\sum }_{1 \leq j \leq i} {t}_{i} ) \} \qquad ( 2 )$$

$$where$$

$$( {t}_{i} , {d}_{i} ) = IntraStagePareto ( i , {l}_{i} , ( {n}_{i} , {m}_{i} ) ) [ {f}_{i} ] \qquad ( 3 )$$

where fᵢ is the sampled index from the pareto frontier introduced in the next section. One may directly combine the checkpointing tuning into the pareto frontier as it also serves as a trade-off between tᵢ and dᵢ. Objective (2) can be reformulated into a mixed integer linear programming problem and solved by the off-the-shelf solver [28].

### 4.3.2 Intra-Stage Tuning

As Objective (4) shows, given stage partitioning, device assignment, gradient accumulation steps, and memory budget, intra-stage tuning finds the best 2D parallelism and offloading combinations to maximize the throughput and sample pareto frontier.

$${min}_{p , z , o} α \cdot ( G - 1 ) \cdot {t}_{p , z , o} + ( 1 - α ) \cdot {d}_{p , z , o} \qquad ( 4 )$$

$$i . e . max ( {Mem}_{peak}^{( fwd )} , {Mem}_{peak}^{( bwd )} ) \leq {Mem}_{Budget}$$

where α∈[0, 1] are sampled uniformly to construct a pareto frontier efficiently. And the stable microbatch time t and delta time d of a certain gradient accumulation step G and strategy tuple (2D parallelism p, ZeRO (SDP) config z, and offloading configs o) can be gotten from the interference model.

$${t}_{p , z , o} = ℐ ( {c}_{p , z , o}^{stable} , {nccl}_{p , z , o}^{stable} , d 2 {h}_{p , z , o}^{stable} , h 2 {d}_{p , z , o}^{stable} ) \qquad ( 5 )$$

$${d}_{p , z , o} = ℐ ( {c}_{p , z , o}^{first} , {nccl}_{p , z , o}^{first} , d 2 {h}_{p , z , o}^{first} , h 2 {d}_{p , z , o}^{first} ) - {t}_{p , z , 0} \qquad ( 6 )$$

where I is the interference model proposed before, c means the computation time, nccl means the GPU-GPU communication time, d2h means the device to host copy time, and h2d means the host to device copy time. The superscript stable suggests the time of a stable micro batch, while first suggest the time of the first micro batch. All the statistics of runtime and memories are reported by the symbolic analyzer. With the help of the symbolic analyzer, querying a single datapoint is simply an expression evaluation (replacing the symbols with concrete values). Furthermore, because expression evaluation can be batched, it becomes much more efficient. Thus, to get the best strategy, one may search in a brute-force way, which would not miss any optimization possibilities, ensuring the optimal solution.

### 5. Evaluation

Mist has been prototyped with ˜27K LoC in Python. To support all optimizations, this exercise has implemented it from scratch based on PyTorch [58], supporting symbolic torch tracing and execution, model automatic pipelining, overlapped offloading and SDP execution, and memory buffer optimizations.

Mist has been evaluated on various training configurations with different hardware, models, and hyper-parameters to demonstrate its ability to effectively find the optimal combination of memory optimizations and parallelism. The results show that Mist can consistently outperform state-of-the-art distributed training systems. One may use training throughput (samples per second) as a primary metric. Since all optimizations applied by Mist are lossless, the fidelity of computation is preserved, ensuring the model convergence is not affected. Additionally, one can provide speedup breakdown, sensitivity studies, prediction accuracies, tuning time, and case studies to explore the sources of the speedup and provide insights.

### 5.1 Methodology

Hardware Settings. To fully study the capabilities of Mist, one may evaluate its training performance on both PCIe systems and NVLink systems, as they offer different combinations of hardware resources. One may conduct the major experiments on up to 4 GCP G2 VMs, each equipped with 8 NVIDIA L4 GPUs [56], and up to 4 AWS EC2 p4d.24xlarge instances, each equipped with 8 NVIDIA A100 GPUs [55]. Detailed hardware specifications are shown in Table 3.

Workloads Setting. Three representative types of LLMs were selected, GPT-3[8], LLaMa [25, 77, 78], and Falcon [2]. All are transformer-based models with some variation in their components. GPT-3 consists of typical transformer decoder layers[8]. LLaMa integrates techniques like pre-RMSNorm [84], gated functions [71], rotary embedding [74], among others, to improve performance on tasks involving long-range dependencies [25, 77, 78]. Falcon adopts parallel attention and MLP layers inspired by GPT-J [14] and GPT-NeoX [7], reducing the number of all-reduce operations associated with tensor parallelism from two to one per layer [2]. Following common practice, one may scale the number of GPUs and the global batch size with the size of the model. To minimize the impact of different frameworks and kernel implementations, set the dropout ratio to zero and disable all biases in the linear layers. Table 4 shows the workloads specifications.

TABLE 3
Hardware Specifications

| Platform | GPU | GPU# | Mem. | PCle Spec | NVLink | Interconnect |
|---|---|---|---|---|---|---|
| GCP | L4 | [2, 4, 8, 16, 32] | 24 GB | Gen3@16x | X | 100 Gbps |
| AWS | A100 | [2, 4, 8, 16, 32] | 40 GB | Gen4@16x | ✓ | 400 Gbps |

TABLE 4
Workload Specifications

| GPU | Models | Param# (billion) | Global Batch Size | Seq Len |
|---|---|---|---|---|
| L4 | GPT, Llama, Falcon | [1.3, 2.6, 6.7, 13, 22] | [32, 64, 128, 256, 512] | 2048 |
| A100 | GPT, Llama, Falcon | [1.3, 2.6, 6.7, 13, 22] | [32, 64, 128, 256, 512] | 4096 |

Baselines. One may compare Mist with three state-of-the-art deep learning distributed training systems: (1) Megatron-LM [72](core_r0.4.0), (2) DeepSpeed [67](v0.12.6), and (3) Aceso [45].

Megatron-LM and DeepSpeed are state-of-the-art manual implementations. Since they do not support automatic tuning, to achieve the best performance, one may perform a grid search over all possible optimization combinations for single-node distributed training. For multi-node cases, benchmark the best strategies that Mist finds within the same search space as Megatron-LM and DeepSpeed.

Aceso is the state-of-the-art automatic distributed strategy tuner, which can automatically find the best combinations of 3D parallelism and activation checkpointing plans. One may follow its artifact to get its numbers.

In the common practice of training LLMs, FlashAttention [18, 19], a vital kernel for performing the fast and memory-efficient attention mechanism, is applied by default to reduce memory usage and achieve the best performance. When FlashAttention is enabled, only compare with Megatron-LM and DeepSpeed since the Aceso does not support it. Then compare all three baselines on L4 GPUs. For A100 GPUs, only compare Mist with state-of-the-art manual and automatic methods, Megatron-LM and Aceso.

It was attempted to compare against Alpa [87], however it fails to find any feasible solutions on L4 GPUs for the workloads targeted. A conjecture is that Alpa only considers memory usage in the Inter-Op pass by compiling the searched strategy and running it. Since its Intra-Op pass is not memory-aware, it's possible that all strategies proposed by Intra-Op pass causes out-of-memory issues.

### 5.2 End-to-End Training Performance

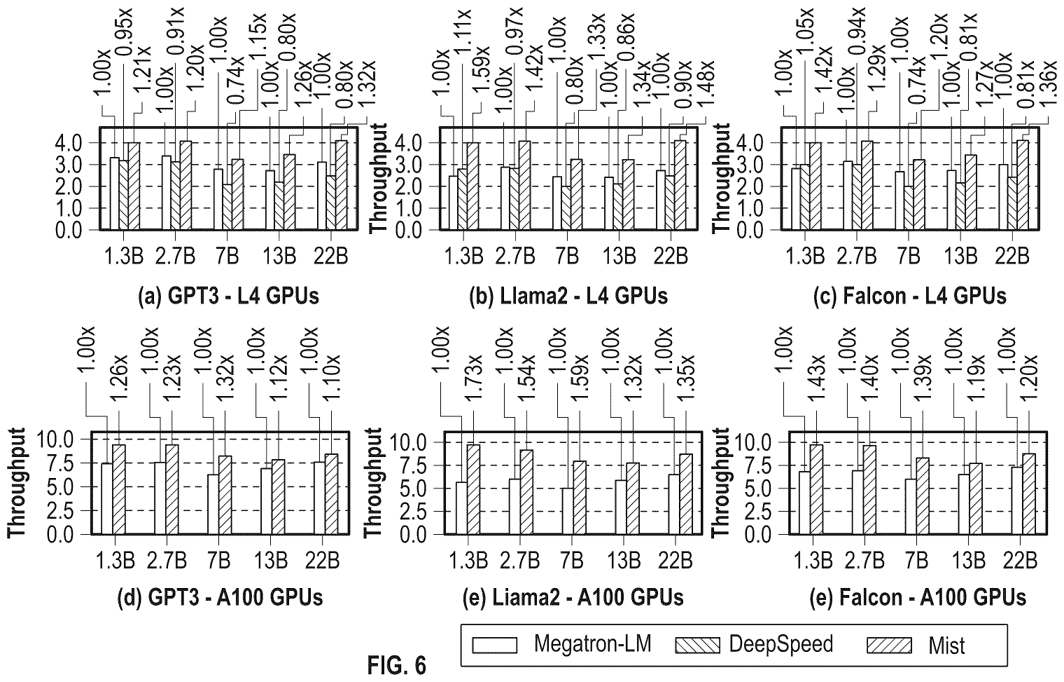

Speedup in Real-World Scenarios. FIG. 6 compares the end-to-end throughput of various distributed training frameworks in real-world scenarios where FlashAttention [18, 19] is enabled. Two key observations may be made. First, Megatron-LM outperforms DeepSpeed in most cases. This is mainly due to the fact that the parallelization plans that work in Megatron-LM cause out-of-memory issues in DeepSpeed, forcing DeepSpeed to choose sub-optimal parallelization strategies. Second, Mist can consistently outperform other distributed training frameworks, achieving an average speedup of 1.32× (up to 1.59×) over Megatron-LM on L4 GPUs, 1.51× on average (up to 1.67×) over DeepSpeed on L4 GPUs, and 1.34× on average (up to 1.72×) over Megatron-LM on A100 GPUs. Specifically for the GPT-3 model, which is the most heavily optimized model in other frameworks, Mist achieves 1.22× speedup on average (up to 1.32×) on L4 GPUs, and 1.20× speedup on average (up to 1.32×) on A100 GPUs, compared with Megatron-LM. The higher speedup for LLaMa model mainly comes from the better RMSNorm kernel implementation and efficient rotary embedding implementation [19]. Overall, it may be concluded that Mist can achieve the best performance over prior state-of-the-art manual implementations across various models and hardware.

Speedup compared with more baselines. FIG. 7 compares the throughput of the GPT-3 model with both manual and automatic parallelization frameworks without FlashAttention. Mist can still consistently outperform or may be equal to all prior distributed training frameworks. Mist achieves an average of 1.14× speedup (up to 1.26× speedup) compared to Megatron-LM and an average of 1.27× speedup (up to 2.04× speedup) compared to Aceso. When training GPT-3 13B on 16 A100 GPUs, Mist does not achieve better performance but still gets almost the same results, because the naive strategy happens to achieve the best trade-off among all resources. It was also found that Aceso does not consistently outperforms Megatron-LM even though it has larger search space due to fine-grained activation checkpointing tuning. The root cause is that Aceso does not include sharded data parallelism in the search space (Shortcoming #1) and miss several essential opportunities for communication-computation overlapping (Shortcoming #2).

Discussion on the hardware. As shown in FIGS. 6 and 7, Mist exhibits higher speedup on L4 GPUs than that on A100 GPUs, with following reasons. Large-scale distributed training tasks on L4 GPUs are often limited by smaller memory capacity and the restricted intra-node and inter-node bandwidth. In this scenario, Mist can play a role in striking the best trade-off among various resources to enhance the resource utilization. On the other hand, training tasks on A100 GPUs benefit from larger memory capacity and faster intra-node NVLink and inter-node InfiniBand connections, resulting in much higher resource utilization that approaches the physical limits. This leaves less room for improvement.

### 5.3 Speedup Breakdown

To understand how each key ideas of Mist contributes to the final performance, one may evaluate it by incrementally enlarging the search space proposed by Mist in FIG. 8. One can normalize the throughput by the baseline search space of Megatron-LM. Three key conclusions are drawn: First, Mist's advantage is not from the better implementation; with the same search space as Megatron-LM, Mist is slightly slower due to implementation overhead supporting other optimizations. Second, activation checkpointing tuning provides a 1.12× speedup on average, with offloading adding an extra 7% speedup, showing their abilities of striking better trade-offs among resources. Third, inter-microbatch imbalance-awareness offers an extra 9% speedup upon all prior speedups, as it provides accurate runtime predictions for pipeline parallelism. In summary, all optimizations included in Mist are important to improve the system performance. Additionally, speedups may vary depending on hardware resources and workload intensity. On A100 GPUs with moderate workloads, most speedups come from activation checkpointing tuning. However, when memory pressure is high, combining it with offloading becomes important. For instance, training a 40B GPT-3 model on 32 A100 GPUs, Mist is expected to get 1.10× speedup compared to 1.04× with only activation checkpointing tuning.

### 5.4 Sensitivity Study

To comprehensively understand the robustness of Mist, one may evaluate its performance with different model scales and different global batch sizes.

Robustness over Different Model Scales. As depicted in FIG. 9, Mist can consistently outperform the baseline search spaces by up to 1.32× higher throughput, particularly at 80 layers, regardless of whether FlashAttention is enabled. Activation checkpointing tuning is particularly effective for smaller model sizes. However, as model size increases, the speedup from checkpointing alone decreases. With the entire search space enabled, Mist maintains substantial speedups across different model sizes.

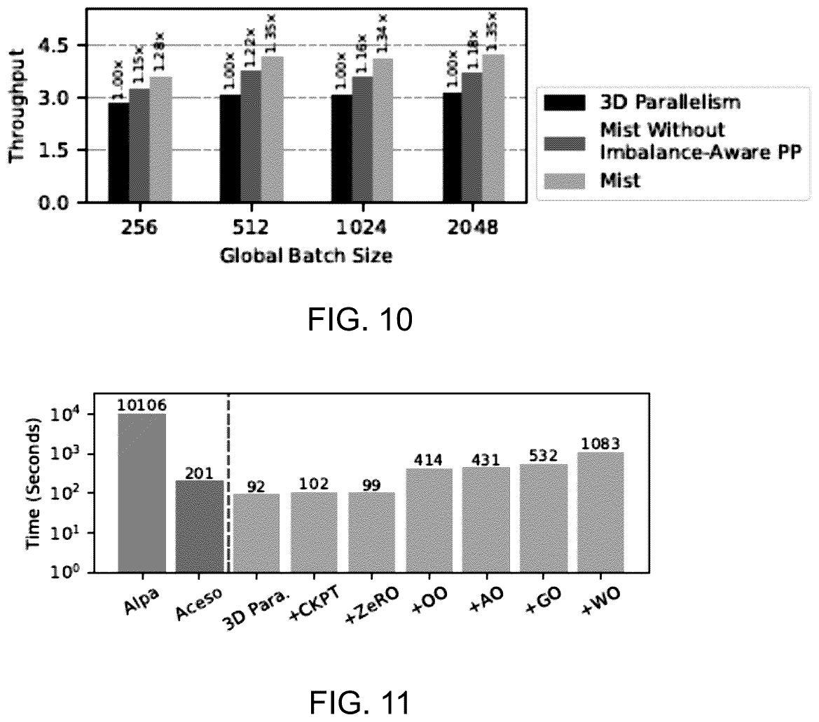

Robustness over Different Global Batch Sizes. As shown in FIG. 10, Mist achieves the best performance compared to the baseline search space across different global batch sizes. Notably, Imbalance-Aware Inter-Stage Tuning provides an extra 1.13× speedup on average. One concern is that with larger global batch sizes and potentially more microbatches, the benefit of imbalance-aware inter-stage tuning might diminish, as treating all microbatches as the same might seem sufficient. However, the sub-optimal strategy produced by inaccurate predictions lead to a significant performance gap due to the larger gradient accumulation steps while Mist's inter-microbatch awareness avoids it.

### 5.5 Tuning Time Comparison

As FIG. 11 shows, to understand the tuning efficiency of Mist, one may evaluate the tuning time by enabling optimizations one by one and compare it with the tuning time of Alpa [87] and Aceso [45]. For Alpa, choose 6 data points because it doesn't automatically tune the gradient accumulation steps and layer grouping size. One may make three observations: First, Mist helps to reduce the tuning time a lot compared to Alpa. Second, when Mist is configured to use a similar search space as Aceso, which is branded as an efficient distributed training searching system, Mist can be faster. Third, even when Mist enables more optimization and greatly increases the search space, the tuning time remains reasonable compared to the significantly longer training time. Moreover, since searching over different gradient accumulation steps is independent, Mist's tuning can be parallelized across different CPU cores or machines to make it faster.

TABLE 5
Optimal configuration for GPT-3 7B on 8 L4 GPUs

| Stage | | | | | | | | | Peak Stage |
|---|---|---|---|---|---|---|---|---|---|
| Id | #L | #CKPT | BS | (DP, TP) | OO | AO | G | Tstable | Mem (GB) |
| 0, 1 | 8 | 8 | 1 | (2, 1) | — | — | 64 | 0.64, 0.60 | 18.27, 16.24 |
| 2, 3 | | | | | | | | 0.60, 0.68 | 16.24, 18.19 |
| 0 | 7 | 5 | 2 | (2, 1) | 0 | 0.375 | 32 | 1.07 | 18.96 |
| 1 | 8 | 1 | 2 | (2, 1) | 0.5 | 0.375 | | 1.00 | 18.22 |
| 2 | 9 | 0 | 2 | (2, 1) | 0.875 | 0 | | 1.02 | 17.39 |
| 3 | 8 | 0 | 2 | (2, 1) | 0.375 | 0 | | 1.00 | 18.44 |

### 5.6 Accuracy of Symbolic Shape Analysis System

The effectiveness of Mist's tuning system may rely on the performance prediction accuracy. Therefore, one may sample different strategies and benchmark the accuracy of the predicted runtime and memory usage compared with the actual ones. Mist consistently demonstrates a high prediction accuracy for both runtime and memory usage. The averaged runtime error ratio is 1.79%, and average memory footprint error ratio is 2.10%. For runtime, the analysis system focuses more on the magnitude comparison to determine the best strategy. As a result, some minor times, such as the optimizer step time, are not included. To better understand runtime accuracy, one may shift the predicted runtime so that the mean values of predicted and actual runtime match.

### 5.7 Case Study

Table 5 above shows a case study the best configurations for running GPT-4 7B on 8 L4 GPUs for Megatron-LM and Mist, where Mist achieves 22% speedup over Megatron-LM. #L denotes the number of layers, #CKPT denotes the number of checkpointed layers, BS is batch size, and OO and AO represent the optimizer state offloading ratio and activation offloading ratio, respectively. Tstable and Tdelta mean tᵢ and dᵢ in Equ (2). The best configuration for Megatron-LM uses 2-way data parallelism and 4-way pipeline parallelism with 64 gradient accumulation steps. Mist discovers a sophisticated schedule plan that is difficult for humans to identify.

One may derive three insights from the schedules that Mist finds: First, Mist co-optimizes the memory optimizations with parallelism, as it aggressively applies the optimizer offloading, utilize the reduced memory to reduce recomputation overhead, and shifts a layer from the first stage to the third stage for a more balanced pipeline partition. Second, Mist is overlap-aware as it enlarges the batch sizes to increase the computation time, better overlapping with communication overhead. It also utilizes the pipeline parallelism overlap to hide overhead of optimizer offloading. Third, Mist is also inter-microbatch imbalance-aware, as it carefully chooses the choices between optimizer offloading and activation offloading to mitigate the pipeline bottleneck.

### 6. Other Related Work

DNN Performance Modeling. The closest works to ours with respect to the performance modeling aspect are Dist-Sim, Proteus and dPRO [23, 33, 47]. These works propose simulation-based approaches to predict model performance. Mist differs in that one may consider an expanded search space including both recomputation and offloading in addition to parallelism strategies. This requires additional sophisticated modeling with respect to interference covered in section 4.2. Moreover, Mist employs a symbolic modeling first approach that is well-suited for the efficiency that the expanded search space demands. DistIR [70] is a work that also employs an analytical-based approach but employs a cost-model predictor of operator latencies. Habitat [83] profiles operators in tandem with methods to extrapolate performance to other GPUs for non-distributed scenarios.

Acceleration Techniques. Techniques like DL compilation and kernel optimizations (e.g., TVM, Hidet, FlashAttention) are largely different than Mist, since they mainly focus on lower-level, static graph optimizations from the graph to hardware level [4, 16, 18, 19, 22, 29, 32, 44]. Additionally, approaches such as gradient compression, quantization, and sparsity, and automatic mixed precision [6, 10, 13, 51, 82] are also orthogonal to Mist: they could be integrated into Mist's schedule template as additional optimization techniques that can improve system performance and memory efficiency. Some of these may also be potentially lossy optimizations, i.e., downgrading the accuracy of DL models, whereas Mist exclusively targets system-level improvements without compromising training accuracy.

### 7. CONCLUSION

The present disclosure thus proposes Mist, which enables efficient deep neural network training by co-optimizing the memory footprint and parallelism strategy of these models in a comprehensive manner. Mist contributes an overlap-centric schedule template, an interference-aware symbolic analysis system, and an imbalance-aware hierarchical auto-tuner to allow efficient optimization in a large search space over optimizations with complex interactions. As a result, Mist can achieves 1.27× (up to 2.04×) over state-of-the-art methods such as Aceso. We hope that Mist will be able to help democratize deep neural network training for machine learning researchers and practitioners alike.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### REFERENCES

[1] Martin Abadi, Paul Barham, Jianmin Chen, Zhifeng Chen, Andy Davis, Jeffrey Dean, Matthieu Devin, Sanjay Ghemawat, Geoffrey Irving, Michael Isard, et al. {TensorFlow}: a system for {Large-Scale}machine learning. In 12th USENIX symposium on operating systems design and implementation (OSDI 16), pages 265-283, 2016.

[2] Ebtesam Almazrouei, Hamza Alobeidli, Abdulaziz Alshamsi, Alessandro Cappelli, Ruxandra Cojocaru, Merouane Debbah, Etienne Goffinet, Daniel Hesslow, Julien Launay, Quentin Malartic, et al. The falcon series of open language models. arXiv preprint arXiv:2311.16867, 2023.

[3] Muralidhar Andoorveedu, Zhanda Zhu, Bojian Zheng, and Gennady Pekhimenko. Tempo: Accelerating transformer-based model training through memory footprint reduction. Advances in Neural Information Processing Systems, 35:12267-12282, 2022.

[4] Jason Ansel, Edward Yang, Horace He, Natalia Gimelshein, Animesh Jain, Michael Voznesensky, Bin Bao, David Berard, Geeta Chauhan, Anjali Chourdia, et al. PyTorch 2: Faster Machine Learning Through Dynamic Python Bytecode Transformation and Graph Compilation. 2024. To appear at ASPLOS.

[5] Anthropic. Claude. https://claude.ai/, 2024.

[6] Youhui Bai, Cheng Li, Quan Zhou, Jun Yi, Ping Gong, Feng Yan, Ruichuan Chen, and Yinlong Xu. Gradient Compression Supercharged High-Performance Data Parallel DNN Training. In Proceedings of the ACM SIGOPS 28th Symposium on Operating Systems Principles, 2021.

[7] Sid Black, Stella Biderman, Eric Hallahan, Quentin Anthony, Leo Gao, Laurence Golding, Horace He, Connor Leahy, Kyle McDonell, Jason Phang, Michael Pieler, USVSN Sai Prashanth, Shivanshu Purohit, Laria Reynolds, Jonathan Tow, Ben Wang, and Samuel Weinbach. GPT-NeoX-20B: An open-source autoregressive language model. In Proceedings of the ACL Workshop on Challenges & Perspectives in Creating Large Language Models, 2022.

[8] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. Language models are few-shot learners. Advances in neural information processing systems, 33:1877-1901, 2020.

[9] Zhenkun Cai, Kaihao Ma, Xiao Yan, Yidi Wu, Yuzhen Huang, James Cheng, Teng Su, and F. Yu. Tensoropt: Exploring the tradeoffs in distributed dnn training with auto-parallelism. IEEE Transactions on Parallel and Distributed Systems, PP:1-1, 2020.

[10] Beidi Chen, Tri Dao, Kaizhao Liang, Jiaming Yang, Zhao Song, Atri Rudra, and Christopher Ré. Pixelated Butterfly: Simple and Efficient Sparse training for Neural Network Models. In The Tenth International Conference on Learning Representations, ICLR, 2022.

[11] Chang Chen, Xiuhong Li, Qianchao Zhu, Jiangfei Duan, Peng Sun, Xingcheng Zhang, and Chao Yang. Centauri: Enabling efficient scheduling for communication-computation overlap in large model training via communication partitioning. In Proceedings of the 29th ACM International Conference on Architectural Support for Programming Languages and Operating Systems, Volume 3, pages 178-191, 2024.

[12] Hongzheng Chen, Cody Hao Yu, Shuai Zheng, Zhen Zhang, Zhiru Zhang, and Yida Wang. Slapo: A Schedule Language for Progressive Optimization of Large Deep Learning Model Training, 2023.

[13] Jianfei Chen, Lianmin Zheng, Zhewei Yao, Dequan Wang, Ion Stoica, MichaelWMahoney, and Joseph E Gonzalez. ActNN: Reducing Training Memory Footprint via 2-Bit Activation Compressed Training. In International Conference on Machine Learning (ICML), 2021.

[14] Mark Chen, Jerry Tworek, Heewoo Jun, Qiming Yuan, Henrique Ponde de Oliveira Pinto, Jared Kaplan, Harri Edwards, Yuri Burda, Nicholas Joseph, Greg Brockman, et al. Evaluating large language models trained on code. arXiv preprint arXiv:2107.03374, 2021.

[15] Tianqi Chen and Carlos Guestrin. Xgboost: A scalable tree boosting system. In Proceedings of the 22nd acm sigkdd international conference on knowledge discovery and data mining, pages 785-794, 2016.

[16] Tianqi Chen, Thierry Moreau, Ziheng Jiang, Lianmin Zheng, Eddie Yan, Meghan Cowan, Haichen Shen, Leyuan Wang, Yuwei Hu, Luis Ceze, Carlos Guestrin, and Arvind Krishnamurthy. TVM: an automated end-to-end optimizing compiler for deep learning. In Proceedings of the 13th USENIX Conference on Operating Systems Design and Implementation, 2018.

[17] Tianqi Chen, Bing Xu, Chiyuan Zhang, and Carlos Guestrin. Training deep nets with sublinear memory cost. arXiv preprint arXiv:1604.06174, 2016.

[18] Tri Dao. FlashAttention-2: Faster attention with better parallelism and work partitioning. 2023.

[19] Tri Dao, Daniel Y. Fu, Stefano Ermon, Atri Rudra, and Christopher Re. FlashAttention: Fast and memory-efficient exact attention with 10-awareness. In Advances in Neural Information Processing Systems, 2022.

[20] Jeffrey Dean, Greg Corrado, Rajat Monga, Kai Chen, Matthieu Devin, Mark Mao, Marc'aurelio Ranzato, Andrew Senior, Paul Tucker, Ke Yang, et al. Large scale distributed deep networks. Advances in neural information processing systems, 25, 2012.

[21] Jacob Devlin, Ming-Wei Chang, Kenton Lee, and Kristina Toutanova. Bert: Pre-training of deep bidirectional transformers for language understanding. arXiv preprint arXiv:1810.04805, 2018.

[22] Yaoyao Ding, Cody Hao Yu, Bojian Zheng, Yizhi Liu, Yida Wang, and Gennady Pekhimenko. Hidet: Task-Mapping Programming Paradigm for Deep Learning Tensor Programs. In Proceedings of the 28th ACM International Conference on Architectural Support for Programming Languages and Operating Systems, Volume 2, 2023.

[23] Jiangfei Duan, Xiuhong Li, Ping Xu, Xingcheng Zhang, Shengen Yan, Yun Liang, and Dahua Lin. Proteus: Simulating the Performance of Distributed DNN Training. arXiv preprint arXiv:2306.02267, 2023.

[24] facebookresearch/llama. llama/model_card.md. https://github.com/facebookresearch/llama/blob/main/MODEL_CARD.md, 2023.

[25] facebookresearch/llama. llama3. https://github.com/meta-Ilama/llama3, 2024.

[26] Shiqing Fan, Yi Rong, Chen Meng, Zongyan Cao, Siyu Wang, Zhen Zheng, Chuan Wu, Guoping Long, Jun Yang, Lixue Xia, et al. Dapple: A pipelined data parallel approach for training large models. In Proceedings of the 26th ACM SIGPLAN Symposium on Principles and Practice of Parallel Programming, pages 431-445, 2021.

[27] Yangyang Feng, Minhui Xie, Zijie Tian, Shuo Wang, Youyou Lu, and Jiwu Shu. Mobius: Fine tuning large-scale models on commodity gpu servers. In Proceedings of the 28th ACM International Conference on Architectural Support for Programming Languages and Operating Systems, Volume 2, pages 489-501, 2023.

[28] John Forrest and Robin Lougee-Heimer. Cbc user guide. In Emerging theory, methods, and applications, pages 257-277. INFORMS, 2005.

[29] Google. XLA, 2022. https://www.tensorflow.org/xla.

[30] Cong Guo, Rui Zhang, Jiale Xu, Jingwen Leng, Zihan Liu, Ziyu Huang, Minyi Guo, Hao Wu, Shouren Zhao, Junping Zhao, et al. Gmlake: Efficient and transparent gpu memory defragmentation for largescale dnn training with virtual memory stitching. arXiv preprint arXiv:2401.08156, 2024.

[31] Chaoyang He, Shen Li, Mahdi Soltanolkotabi, and Salman Avestimehr. Pipetransformer: Automated elastic pipelining for distributed training of transformers. arXiv preprint arXiv:2102.03161, 2021.

[32] Horace He and Shangdi Yu. Transcending Runtime-Memory Tradeoffs in Checkpointing by being Fusion Aware. Proceedings of Machine Learning and Systems, 2023.

[33] Hanpeng Hu, Chenyu Jiang, Yuchen Zhong, Yanghua Peng, Chuan Wu, Yibo Zhu, Haibin Lin, and Chuanxiong Guo. dpro: A generic performance diagnosis and optimization toolkit for expediting distributed dnn training. Proceedings of Machine Learning and Systems, 2022.

[34] Yanping Huang, Youlong Cheng, Ankur Bapna, Orhan Firat, Dehao Chen, Mia Chen, HyoukJoong Lee, Jiquan Ngiam, Quoc V Le, Yonghui Wu, et al. Gpipe: Efficient training of giant neural networks using pipeline parallelism. Advances in neural information processing systems, 32, 2019.

[35] Forrest N landola, Matthew W Moskewicz, Khalid Ashraf, and Kurt Keutzer. Firecaffe: near-linear acceleration of deep neural network training on compute clusters. In Proceedings of the IEEE conference on computer vision and pattern recognition, pages 2592-2600, 2016.

[36] Akifumi Imanishi, Zijian Xu, Masayuki Takagi, Sixue Wang, and Emilio Castillo. A fast heuristic to optimize time-space tradeoff for large models. Advances in Neural Information Processing Systems, 36, 2024.

[37] Paras Jain, Ajay Jain, Aniruddha Nrusimha, Amir Gholami, Pieter Abbeel, Joseph Gonzalez, Kurt Keutzer, and Ion Stoica. Checkmate: Breaking the memory wall with optimal tensor rematerialization. Proceedings of Machine Learning and Systems, 2:497-511, 2020.

[38] Chiheon Kim, Heungsub Lee, Myungryong Jeong, Woonhyuk Baek, Boogeon Yoon, Ildoo Kim, Sungbin Lim, and Sungwoong Kim. torchgpipe: On-the-fly pipeline parallelism for training giant models. arXiv preprint arXiv:2004.09910, 2020.

[39] Marisa Kirisame, Steven Lyubomirsky, Altan Haan, Jennifer Brennan, Mike He, Jared Roesch, Tianqi Chen, and Zachary Tatlock. Dynamic tensor rematerialization. In International Conference on Learning Representations, 2020.

[40] Vijay Anand Korthikanti, Jared Casper, Sangkug Lym, Lawrence McAfee, Michael Andersch, Mohammad Shoeybi, and Bryan Catanzaro. Reducing activation recomputation in large transformer models. Proceedings of Machine Learning and Systems, 5, 2023.

[41] Zhiquan Lai, Shengwei Li, Xudong Tang, Keshi Ge, Weijie Liu, Yabo Duan, Linbo Qiao, and Dongsheng Li. Merak: An efficient distributed dnn training framework with automated 3d parallelism for giant foundation models. IEEE Transactions on Parallel and Distributed Systems, 34(5):1466-1478, 2023.

[42] Shen Li, Yanli Zhao, Rohan Varma, Omkar Salpekar, Pieter Noordhuis, Teng Li, Adam Paszke, Jeff Smith, Brian Vaughan, Pritam Damania, et al. Pytorch distributed: Experiences on accelerating data parallel training. arXiv preprint arXiv:2006.15704, 2020.

[43] Zhuohan Li, Siyuan Zhuang, Shiyuan Guo, Danyang Zhuo, Hao Zhang, Dawn Song, and Ion Stoica. Terapipe: Token-level pipeline parallelism for training large-scale language models. In International Conference on Machine Learning, pages 6543-6552. PMLR, 2021.

[44] Bin Lin, Ningxin Zheng, Lei Wang, Shijie Cao, Lingxiao Ma, Quanlu Zhang, Yi Zhu, Ting Cao, Jilong Xue, Yuqing Yang, et al. Efficient GPU Kernels for N: M-Sparse Weights in Deep Learning. Proceedings of Machine Learning and Systems, 2023.

[45] Guodong Liu, Yushan Miao, Zhiqi Lin, Xiaoxiang Shi, Saeed Maleki, Fan Yang, Yungang Bao, and Sa Wang. Aceso: Efficient parallel dnn training through iterative bottleneck alleviation. In Proceedings of the Nineteenth European Conference on Computer Systems, pages 163-181, 2024.

[46] Ze Liu, Yutong Lin, Yue Cao, Han Hu, Yixuan Wei, Zheng Zhang, Stephen Lin, and Baining Guo. Swin transformer: Hierarchical vision transformer using shifted windows. In Proceedings of the IEEE/CVF international conference on computer vision, pages 10012-10022, 2021.

[47] Guandong Lu, Runzhe Chen, Yakai Wang, Yangjie Zhou, Rui Zhang, Zheng Hu, Yanming Miao, Zhifang Cai, Li Li, Jingwen Leng, and Minyi Guo. DistSim: A performance model of large-scale hybrid distributed DNN training. In Proceedings of the 20th ACM International Conference on Computing Frontiers, 2023.

[48] Wenyan Lu, Guihai Yan, Jiajun Li, Shijun Gong, Yinhe Han, and Xiaowei Li. Flexflow: A flexible dataflow accelerator architecture for convolutional neural networks. In 2017 IEEE International Symposium on High Performance Computer Architecture (HPCA), pages 553-564. IEEE, 2017.

[49] meta llama/llama3. llama/model_card.md. https://github.com/metallama/llama3/blob/main/MODEL_CARD.md, 2024.

[50] Xupeng Miao, Yujie Wang, Youhe Jiang, Chunan Shi, Xiaonan Nie, Hailin Zhang, and Bin Cui. Galvatron: Efficient transformer training over multiple gpus using automatic parallelism. Proc. VLDB Endow., 16(3):470-479, 2023.

[51] Paulius Micikevicius, Sharan Narang, Jonah Alben, Gregory F. Diamos, Erich Elsen, David Garcia, Boris Ginsburg, Michael Houston, Oleksii Kuchaiev, Ganesh Venkatesh, and Hao Wu. Mixed Precision Training. In 6th International Conference on Learning Representations, ICLR, 2018.

[52] Deepak Narayanan, Aaron Harlap, Amar Phanishayee, Vivek Seshadri, Nikhil R Devanur, Gregory R Ganger, Phillip B Gibbons, and Matei Zaharia. Pipedream: Generalized pipeline parallelism for dnn training. In Proceedings of the 27th ACM Symposium on Operating Systems Principles, pages 1-15, 2019.

[53] Deepak Narayanan, Amar Phanishayee, Kaiyu Shi, Xie Chen, and Matei Zaharia. Memory-efficient pipeline-parallel dnn training. In International Conference on Machine Learning, pages 7937-7947. PMLR, 2021.

[54] Deepak Narayanan, Mohammad Shoeybi, Jared Casper, Patrick LeGresley, Mostofa Patwary, Vijay Korthikanti, Dmitri Vainbrand, Prethvi Kashinkunti, Julie Bernauer, Bryan Catanzaro, et al. Efficient largescale language model training on gpu clusters using megatron-Im. In Proceedings of the International Conference for High Performance Computing, Networking, Storage and Analysis, pages 1-15, 2021.

[55] NVIDIA. NVIDIA A100 GPUs. https://www.nvidia.com/en-us/datacenter/a100/.

[56] NVIDIA. NVIDIA L4 GPUs. https://www.nvidia.com/en-us/datacenter/14/.

[57] openai. Chatgpt. https://openai.com/chatgpt/, 2022.

[58] Adam Paszke, Sam Gross, Francisco Massa, Adam Lerer, James Bradbury, Gregory Chanan, Trevor Killeen, Zeming Lin, Natalia Gimelshein, Luca Antiga, et al. Pytorch: An imperative style, high performance deep learning library. Advances in neural information processing systems, 32, 2019.

[59] Suchita Pati, Shaizeen Aga, Mahzabeen Islam, Nuwan Jayasena, and Matthew D Sinclair. T3: Transparent tracking & triggering for fine-grained overlap of compute & collectives. arXiv preprint arXiv:2401.16677, 2024.

[60] Xuan Peng, Xuanhua Shi, Hulin Dai, Hai Jin,Weiliang Ma, Qian Xiong, Fan Yang, and Xuehai Qian. Capuchin: Tensor-based gpu memory management for deep learning. In Proceedings of the Twenty-Fifth International Conference on Architectural Support for Programming Languages and Operating Systems, pages 891-905, 2020.

[61] Penghui Qi, Xinyi Wan, Guangxing Huang, and Min Lin. Zero bubble pipeline parallelism. arXiv preprint arXiv:2401.10241, 2023.

[62] Alec Radford, Karthik Narasimhan, Tim Salimans, Ilya Sutskever, et al. Improving language understanding by generative pre-training. 2018.

[63] Alec Radford, Jeffrey Wu, Rewon Child, David Luan, Dario Amodei, Ilya Sutskever, et al. Language models are unsupervised multitask learners. OpenAl blog, 1(8):9, 2019.

[64] Alec Radford, Jeffrey Wu, Rewon Child, David Luan, Dario Amodei, Ilya Sutskever, et al. Language models are unsupervised multitask learners. OpenAl blog, 1(8):9, 2019.

[65] Samyam Rajbhandari, Jeff Rasley, Olatunji Ruwase, and Yuxiong He. Zero: Memory optimizations toward training trillion parameter models. In SC20: International Conference for High Performance Computing, Networking, Storage and Analysis, pages 1-16. IEEE, 2020.

[66] Samyam Rajbhandari, Olatunji Ruwase, Jeff Rasley, Shaden Smith, and Yuxiong He. Zero-infinity: Breaking the gpu memory wall for extreme scale deep learning. In Proceedings of the International Conference for High Performance Computing, Networking, Storage and Analysis, pages 1-14, 2021.

[67] Jeff Rasley, Samyam Rajbhandari, Olatunji Ruwase, and Yuxiong He. DeepSpeed: System Optimizations Enable Training Deep Learning Models with Over 100 Billion Parameters. In Proceedings of the 26^{th} ACM SIGKDD International Conference on Knowledge Discovery & Data Mining, 2020.

[68] Jie Ren, Samyam Rajbhandari, Reza Yazdani Aminabadi, Olatunji Ruwase, Shuangyan Yang, Minjia Zhang, Dong Li, and Yuxiong He. {ZeRO-Offload}: Democratizing {Billion-Scale}model training. In 2021 USENIX Annual Technical Conference (USENIX ATC 21), pages 551-564, 2021.

[69] Minsoo Rhu, Natalia Gimelshein, Jason Clemons, Arslan Zulfiqar, and Stephen W Keckler. vdnn: Virtualized deep neural networks for scalable, memory-efficient neural network design. In 2016 49th Annual IEEE/ACM International Symposium on Microarchitecture (MICRO), pages 1-13. IEEE, 2016.

[70] Keshav Santhanam, Siddharth Krishna, Ryota Tomioka, Andrew Fitzgibbon, and Tim Harris. Distir: An intermediate representation for optimizing distributed neural networks. In Proceedings of the 1^{st} Workshop on Machine Learning and Systems, 2021.

[71] Noam Shazeer. Glu variants improve transformer. arXiv preprint arXiv:2002.05202, 2020.

[72] Mohammad Shoeybi, Mostofa Patwary, Raul Puri, Patrick LeGresley, Jared Casper, and Bryan Catanzaro. Megatron-Im: Training multibillion parameter language models using model parallelism. arXiv preprint arXiv:1909.08053, 2019.

[73] Emma Strubell, Ananya Ganesh, and Andrew McCallum. Energy and policy considerations for deep learning in nlp. arXiv preprint arXiv:1906.02243, 2019.

[74] Jianlin Su, Murtadha Ahmed, Yu Lu, Shengfeng Pan, Wen Bo, and Yunfeng Liu. Roformer: Enhanced transformer with rotary position embedding. Neurocomputing, 568:127063, 2024.

[75] Zhenbo Sun, Huanqi Cao, Yuanwei Wang, Guanyu Feng, Shengqi Chen, Haojie Wang, and Wenguang Chen. Adapipe: Optimizing pipeline parallelism with adaptive recomputation and partitioning. In Proceedings of the 29th ACM International Conference on Architectural Support for Programming Languages and Operating Systems, Volume 3, pages 86-100, 2024.

[76] Jakub Tarnawski, Deepak Narayanan, and Amar Phanishayee. Piper: Multidimensional planner for dnn parallelization. In Neural Information Processing Systems, 2021.

[77] Hugo Touvron, Thibaut Lavril, Gautier Izacard, Xavier Martinet, Marie-Anne Lachaux, Timothee Lacroix, Baptiste Roziere, Naman Goyal, Eric Hambro, Faisal Azhar, et al. Llama: Open and efficient foundation language models. arXiv preprint arXiv:2302.13971, 2023.

[78] Hugo Touvron, Louis Martin, Kevin Stone, Peter Albert, Amjad Almahairi, Yasmine Babaei, Nikolay Bashlykov, Soumya Batra, Prajjwal Bhargava, Shruti Bhosale, et al. Llama 2: Open foundation and finetuned chat models. arXiv preprint arXiv:2307.09288, 2023.

[79] Linnan Wang, Jinmian Ye, Yiyang Zhao, Wei Wu, Ang Li, Shuaiwen Leon Song, Zenglin Xu, and Tim Kraska. Superneurons: Dynamic gpu memory management for training deep neural networks. In Proceedings of the 23rd ACM SIGPLAN symposium on principles and practice of parallel programming, pages 41-53, 2018.

[80] Minjie Wang, Chien-chin Huang, and Jinyang Li. Supporting very large models using automatic dataflow graph partitioning. In Proceedings of the Fourteenth EuroSys Conference 2019, pages 1-17, 2019.

[81] Shibo Wang, Jinliang Wei, Amit Sabne, Andy Davis, Berkin llbeyi, Blake Hechtman, Dehao Chen, Karthik Srinivasa Murthy, Marcello Maggioni, Qiao Zhang, et al. Overlap communication with dependent computation via decomposition in large deep learning models. In Proceedings of the 28th ACM International Conference on Architectural Support for Programming Languages and Operating Systems, Volume 1, pages 93-106, 2022.

[82] ZhuangWang, XinyuWu, Zhaozhuo Xu, and TS Ng. Cupcake: A Compression Scheduler for Scalable Communication-Efficient Distributed Training. Proceedings of Machine Learning and Systems, 5, 2023.

[83] Geoffrey X Yu, Yubo Gao, Pavel Golikov, and Gennady Pekhimenko. Habitat: A {Runtime-Based}computational performance predictor for deep neural network training. In 2021 USENIX Annual Technical Conference (USENIX ATC 21), 2021.

[84] Biao Zhang and Rico Sennrich. Root mean square layer normalization. Advances in Neural Information Processing Systems, 32, 2019.

[85] Yanli Zhao, Andrew Gu, Rohan Varma, Liang Luo, Chien-Chin Huang, Min Xu, LessWright, Hamid Shojanazeri, Myle Ott, Sam Shleifer, et al. Pytorch fsdp: experiences on scaling fully sharded data parallel. arXiv preprint arXiv:2304.11277, 2023.

[86] Bojian Zheng, Nandita Vijaykumar, and Gennady Pekhimenko. Echo: Compiler-based gpu memory footprint reduction for Istm rnn training. In 2020 ACM/IEEE 47th Annual International Symposium on Computer Architecture (ISCA), pages 1089-1102. IEEE, 2020.

[87] Lianmin Zheng, Zhuohan Li, Hao Zhang, Yonghao Zhuang, Zhifeng Chen, Yanping Huang, Yida Wang, Yuanzhong Xu, Danyang Zhuo, Eric P Xing, et al. Alpa: Automating inter- and {lntra-Operator}parallelism for distributed deep learning. In 16th USENIX Symposium on Operating Systems Design and Implementation (OSDI 22), pages 559-578, 2022.

1. A method of performing distributed training of models, comprising:
co-optimizing memory optimizations with parallelism to increase model training throughput under a memory constraint by orchestrating a plurality of optimizations to utilize system resources in consideration of computation, communication and memory footprint.

2. The method of claim 1, comprising obtaining an overlap-centric schedule template that determines granularity and order of how techniques utilized by the plurality of optimizations are applied to a model.

3. The method of claim 2, wherein the overlap-centric schedule template mitigates tuning complexity by applying heuristics to orchestrate optimizations in an overlapped manner.

4. The method of claim 2, comprising:
obtaining the model and corresponding input data; and
annotating the model and input data with symbolic shapes and applying a symbolic tracer to obtain a symbolic shape computational graph.

5. The method of claim 4, comprising analyzing the symbolic shape computational graph and the overlap-centric schedule template to derive a peak memory expression and runtime function whose inputs are optimization-related symbols.

6. The method of claim 5, wherein a single simulation pass is run for optimizations represented as symbols and symbolic expressions or functions of the system metrics are output.

7. The method of claim 5, comprising decoupling tuning into inter-stage and intra-stage tuning using an imbalance-aware hierarchical auto-tuner.

8. The method of claim 7, wherein inter-stage tuning addresses inter-stage and inter-microbatch imbalances inherent in pipeline parallelism.

9. The method of claim 7, wherein intra-stage tuning evaluates the symbolic memory expression and runtime function with optimization values in a batched way to find a pareto-optimal series of 2D parallelism and offloading plans for each potential inter-stage candidate.

10. The method of claim 5, comprising utilizing an execution engine to perform the optimizations in distributed training operations.

11. The method of claim 10, wherein the execution engine is configured to perform at least one of auto-pipelining, overlapped offloading, and memory buffer optimization.

12. A computing system comprising:
at least one processor; and
at least one memory, the at least one memory storing computer executable instructions for performing distributed training of models, comprising computer executable instructions that, when executed by the at least one processor cause the system to:
co-optimize memory optimizations with parallelism to increase model training throughput under a memory constraint by orchestrating a plurality of optimizations to utilize system resources in consideration of computation, communication and memory footprint.

13. The system of claim 12, comprising instructions to:
obtain an overlap-centric schedule template that determines granularity and order of how techniques utilized by the plurality of optimizations are applied to a model.

14. The system of claim 13, wherein the overlap-centric schedule template mitigates tuning complexity by applying heuristics to orchestrate optimizations in an overlapped manner.

15. The system of claim 13, comprising instructions to:
obtain the model and corresponding input data; and
annotate the model and input data with symbolic shapes and applying a symbolic tracer to obtain a symbolic shape computational graph.

16. The system of claim 15, comprising instructions to:
analyze the symbolic shape computational graph and the overlap-centric schedule template to derive a peak memory expression and runtime function whose inputs are optimization-related symbols.

17. The system of claim 16, comprising decoupling tuning into inter-stage and intra-stage tuning using an imbalance-aware hierarchical auto-tuner.

18. The system of claim 17, wherein inter-stage tuning addresses inter-stage and inter-microbatch imbalances inherent in pipeline parallelism.

19. The system of claim 17, wherein intra-stage tuning evaluates the symbolic memory expression and runtime function with optimization values in a batched way to find a pareto-optimal series of 2D parallelism and offloading plans for each potential inter-stage candidate.

20. A computer readable medium storing computer executable instructions for performing distributed training of models, the computer executable instructions when executed by a processor of a computing system, causing the computing system perform operations comprising:
co-optimizing memory optimizations with parallelism to increase model training throughput under a memory constraint by orchestrating a plurality of optimizations to utilize system resources in consideration of computation, communication and memory footprint.
